(19) United States
(12) Patent Application Publication
(10) Pub. No.: US 2012/0261375 A1
(43) Pub. Date: Oct. 18, 2012

(54) Drinking Cup with Lid and Flow Control Element

(76) Inventor: James A. Loging, Laurens, SC (US)

(21) Appl. No.: 13/527,118

(22) Filed: Jun. 19, 2012

Related U.S. Application Data
(63) Continuation-in-part of application No. 12/804,986, filed on Aug. 3, 2010.

(51) Int. Cl. A61J 11/00; A47G 19/22; A61J 9/00; B65D 1/04

(52) U.S. Cl. 215/11.4; 215/6; 220/714

(57) ABSTRACT

A drinking cup that has a lid that engages a nipple. A cup body engages and is releasably attachable to the lid. A medicine cup is present and medicine is disposed within the medicine cup. The medicine in the medicine cup moves through a flow control element and then through the nipple. Also provided is a drinking cup with a medicine cup and a straw. At least a portion of the straw is located between a lower surface of a lid and a bottom surface of a cup body.

### CROSS REFERENCE TO RELATED APPLICATION

This application is a continuation-in-part and claims the benefit of U.S. application Ser. No. 12/804,986 filed on Aug. 3, 2010 and entitled, “Drinking Cup with Lid and Flow Control Element.” U.S. application Ser. No. 12/804,986 is incorporated by reference herein in its entirety for all purposes.

### FIELD OF THE INVENTION

The present invention relates generally to drinking cups. More particularly, the present application involves a drinking cup that features a medicine cup and a nipple, and a drinking cup that features a medicine cup and a straw.

### BACKGROUND

Drinking cups with lids are commonly used by children for the dispensing of a beverage. These types of cups usually employ a valve arrangement that prevents the beverage from being dispensed from the drinking cup if the cup is turned upside down or dropped by the child. One or more valves are incorporated into a flow control element that can be attached and detached from the bottom of the lid of the drinking cup. The flow control element can be removed from the lid to allow the drinking cup to be more thoroughly cleaned.

The flow control element includes side walls that are straight that frictionally engage corresponding straight side walls of the lid. Although capable of effecting an attachment of these components, forces imparted onto the drinking cup may be sufficient to dislodge the flow control element from the lid thus allowing beverage to leak inadvertently from the drinking cup. For example, if the child drops the drinking cup the flow control element may become disengaged from the lid thus allowing beverage to flow from the drinking cup without being contained by the valve of the flow control element.

Drinking cups may also include a medicine cup into which medicine is placed for subsequent dispensing with other fluid in the drinking cup such as juice. These types of drinking cups allow for accurate measurement of the medicine that was dispensed from the drinking cup and may help to mask the taste of the medicine to thus make it easier to administer medicine to a user such as a child.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended Figs. in which:

FIG. 1 is a cross-sectional view of an assembled drinking cup in accordance with one exemplary embodiment.

FIG. 2 is a close-up, cross-sectional view of the drinking cup of FIG. 1 that illustrates the releasable attachment arrangement between the flow control element and the lid.

FIG. 3 is a top view of the flow control element of the drinking cup of FIG. 1.

FIG. 4 is a bottom view of the lid of the drinking cup of FIG. 1.

FIG. 5 is a close-up cross-sectional view of the releasable attachment arrangement between the flow control element and the lid in accordance with another exemplary embodiment.

FIG. 6 is a close-up, cross-sectional view of the releasable attachment arrangement between the flow control element and the lid in accordance with yet another exemplary embodiment.

FIG. 7 is a cross-sectional view of a drinking cup in accordance with another exemplary embodiment.

FIG. 8 is an exemplary embodiment with a nipple instead of a drinking spout.

FIG. 9 is close-up view of FIG. 8.

FIG. 10 is an exemplary embodiment with a frictional fit.

FIG. 11 is a top view of a lid.

FIG. 12 is a bottom view of a lid.

FIG. 13 is a side view of a nipple engaged with a lid.

FIG. 14 is top view of a flow control element.

FIG. 15 is a bottom view of the flow control element.

FIG. 16 is a top view of a lid.

FIG. 17 is an exploded perspective view of the drinking cup.

FIG. 18 is an alternative exemplary embodiment of the drinking cup.

FIG. 19 is an exemplary embodiment in which straws below the flow control element are not present.

FIG. 20 is an exemplary embodiment in which a straw in the medicine cup is not present.

FIG. 21 is an exemplary embodiment in which a straw in the cup body is not present.

FIG. 22 is an exemplary embodiment with a flip top spout.

FIG. 23 is an exemplary embodiment with a flip top spout in which the only straw is in the medicine cup.

FIG. 24 is an exemplary embodiment with a flip top spout in which the only straw is in the cup body.

Repeat use of reference characters in the present specification and drawings is intended to represent the same or analogous features or elements of the invention.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

The present invention provides for a drinking cup 10 that features a lid 14 that is releasably attached to a flow control element 16. The releasable attachment may be arranged so that when attached it is secure enough to remain attached even when one drops the drinking cup 10. As such, the releasable attachment may be effected so that it only becomes disengaged when one desires it to become disengaged. The releasable attachment may include a flow control element 16 that has an attachment portion 40 with a projection 42 and a lid engagement surface 44 that has a concave shape. The lid 14 may have a receiving portion 14 that features a projection receiving surface 20 and a flow control engagement surface 22 that has a convex shape. The flow control element 16 can be attached to the lid 14 such that the projection 42 engages the projection receiving surface 20 and such that the lid engagement surface 44 engages the flow control engagement surface 22. This type of connection may allow for the lid 14 and flow control element 16 to be more securely attached to one another and removable only upon the intentional application of force to these components.

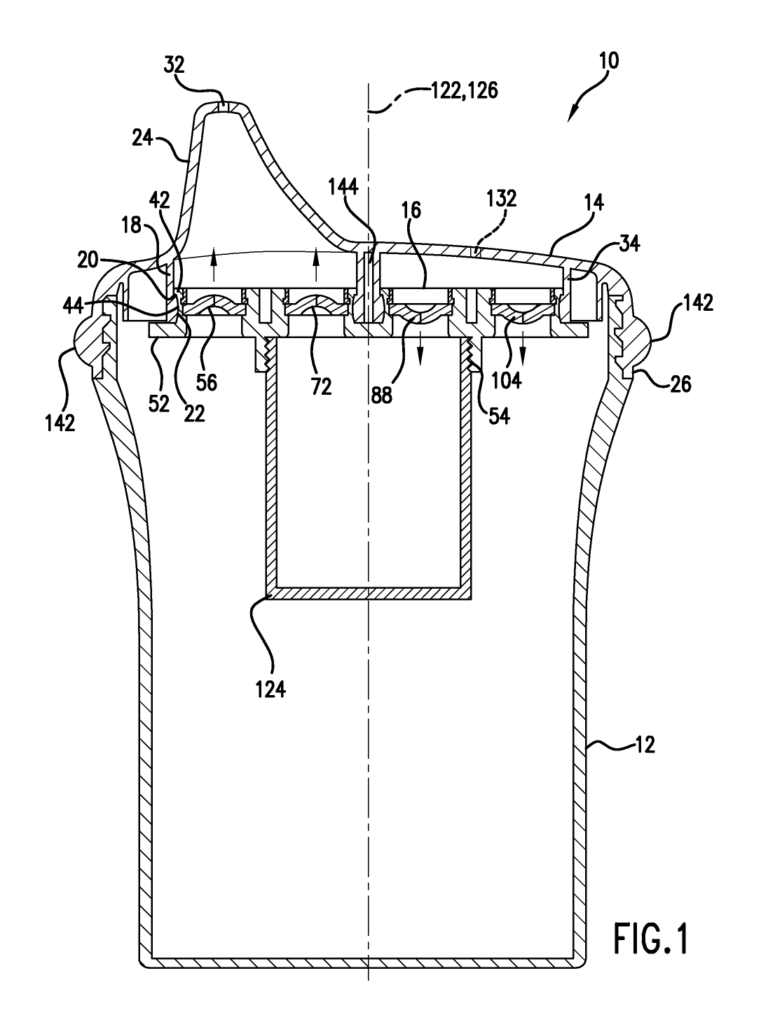

FIG. 1 illustrates a drinking cup 10 in accordance with one exemplary embodiment. The drinking cup 10 includes a cup body 12 that is attached to a lid 14 through a releasable attachment. The cup body 12 has a longitudinal axis 12 that extends through its center. The drinking cup 10 may also feature a medicine cup 124 that likewise has a longitudinal axis 126 through its center. The drinking cup 10 may be arranged so that the longitudinal axes 122 and 126 are coaxial with one another. This arrangement may prevent the flow control element 16 or other components from disengaging should the drinking cup 10 be inadvertently dropped or hit because the weight of the medicine cup 124 and its contents are located at the center of the drinking cup 10 and not off-center thus minimizing any unbalanced jarring. However, it is to be understood that other arrangements are possible in which the medicine cup 124 is not at the center of the cup body 12 such that the longitudinal axes 122 and 126 are not coaxial with one another. The medicine cup 124 may be used to hold medicine to be administered to a child. Drinking contents, such as juice, may be located in the cup body 12 and mixed with the medicine upon dispensing by the child thus masking the presence of the medicine in the drink. The amount of medicine administered can be noted since the medicine is kept separate from the juice or other beverage. However, it is to be understood that a medicine cup 124 need not be present in other arrangements, and that the drinking cup 10 of the present invention need not have a medicine cup 124 or be configured in any special manner for the administration of medicine.

The cup body 12 can be releasably attached to the lid 14 through the use of a threaded connection. In the disclosed arrangement, the top of the cup body 12 has external threading that engages internal threading located on a cup body receiving portion 26 of the lid 14. The lid 14 can be removed from the cup body 12 in order to fill the cup body 12 with a desired beverage or if cleaning is needed. In use, the lid 14 has a drinking spout 24 through which combined beverage and medicine can be dispensed through one or more dispensing openings 32 in the drinking spout 24. The drinking spout 24 may be an integrally formed portion of the lid 14 or can be formed separately therefrom. In certain arrangements, the drinking spout 24 may be a straw through which the user dispenses the contents of the drinking cup 10. The medicine and beverage may mix with one another in a portion of the drinking cup 10 that is located between the lower surface of the lid 14 and the upper surface of the flow control element 16. The mixing may take place in a chamber formed due to the presence of the drinking spout 24.

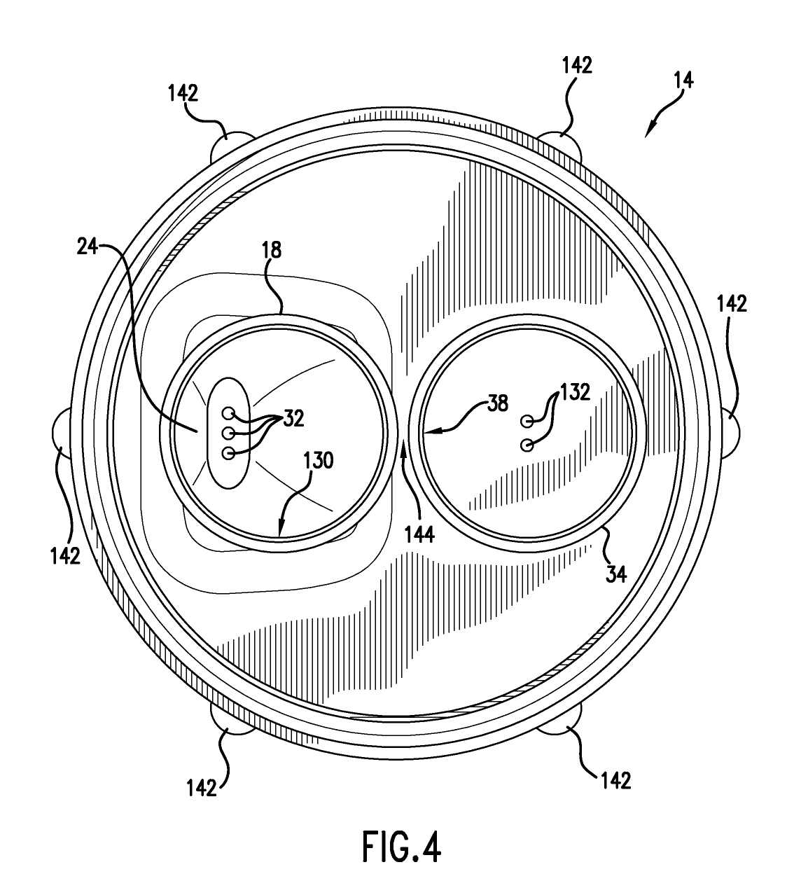

The flow control element 16 is responsible for directing the desired flow of beverage and medicine through the drinking cup 10. The flow control element 16 may be engaged to the lid 14 through a releasable attachment so that these components can be attached and removed by the user as desired. Disengagement may be desired when a user wishes to clean the various components of the drinking cup 10. The lid 14 has a receiving portion 18 that extends downward from a lower surface of the lid 14. The receiving portion 18 may be integrally formed with the other portions of the lid 14 such as the drinking spout 24 or the portions of the lid 14 from which the receiving portion 18 extends. The receiving portion 18 includes a projection receiving surface 20 and a flow control engagement surface 22. In certain arrangements, the projection receiving surface 20 is present and the flow control engagement surface 22 is not present. In yet other exemplary embodiments, the flow control engagement surface 22 is present on the receiving portion 18 and the projection receiving surface 20 is not included. The flow control engagement surface 22 and the projection receiving surface 20 are contiguous with one another such that the projection receiving surface 20 extends from the flow control engagement surface 22. In other embodiments, these two surfaces 20 and 22 are present but are not contiguous with one another such that they do not extend from one another. The receiving portion 18 can have a circular outer perimeter as illustrated in FIG. 4 such that the dispensing openings 32 are located within the outer perimeter of the receiving portion 18 yet displaced upwards in the vertical direction therefrom.

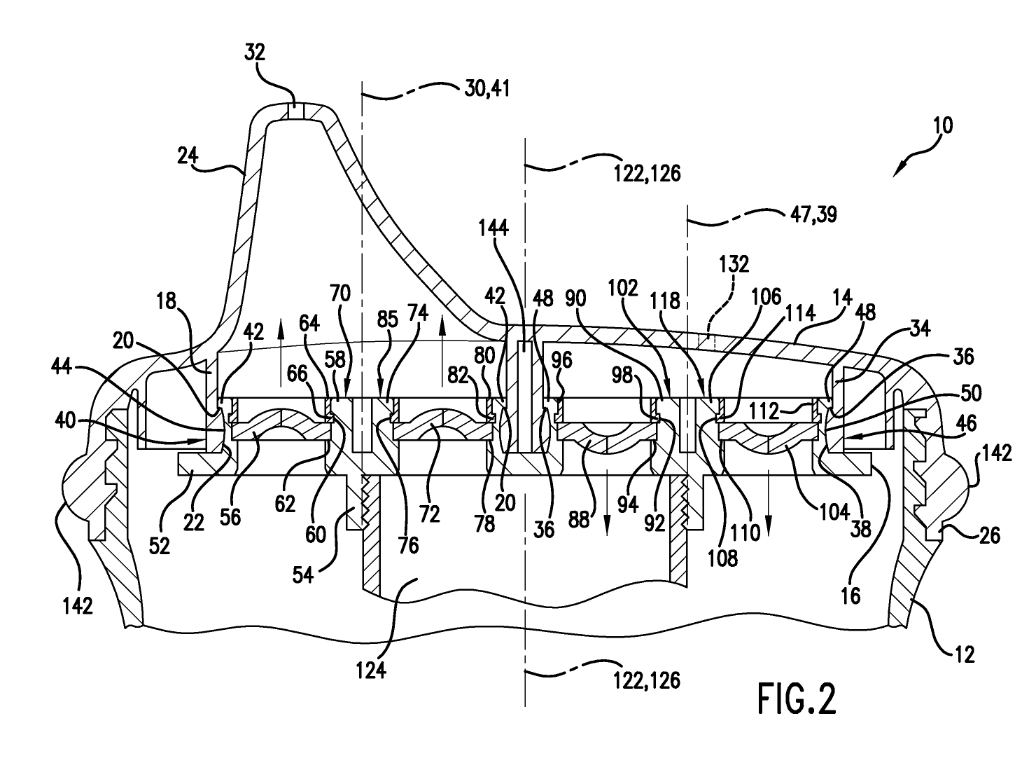

Referring back to FIG. 2, the cross-sectional shape of the receiving portion 18 will now be discussed. The flow control engagement surface 22 has a convex shape from the lowermost portion of the receiving portion 18 to the projection receiving surface 20. However, it is to be understood that other arrangements are possible in which the flow control engagement surface 22 does not have a convex shape but rather is straight, conical, concave, or funnel shaped. In yet other arrangements, a portion of the flow control engagement surface 22 is convex and other portions of the surface 22 are differently shaped such as being straight, concave, funnel, or conical. As such, the flow control engagement surface 22 may be variously shaped in other exemplary embodiments. The projection receiving surface 20 may extend radially outwards from the flow control engagement surface 22 and then may either stop or may extend in the longitudinal direction without extending in the radial direction. As such, the projection receiving surface 20 may be a step of the receiving portion 18 onto which the projection 42 rests and contacts. Alternatively, the projection receiving surface 20 may be both a step and a portion of the inner wall of the receiving portion 18 such that the projection 42 contacts both the step and a portion of the inner wall of the receiving portion 18.

The lid 14 also features a second receiving portion 34. With reference to FIG. 4, the second receiving portion 34 has a circular outer perimeter and is contiguous with the receiving portion 18. One or more vent holes 132 defined through the lid 14 are located within the outer perimeter of the second receiving portion 18 but are spaced upwards vertically therefrom. Referring back to FIG. 2, a portion of the lid 14 extending downwards from the lower surface of the lid 14 defines a portion of both the receiving portion 18 and the second receiving portion 34. The second receiving portion 34 may have a second projection receiving surface 36 and a second flow control engagement surface 38. The surfaces 36 and 38, along with the second receiving portion 34 can be arranged in an identical manner as the surfaces 20 and 22 and receiving portion 18 as previously discussed, and a repeat of this information is not necessary. Also, it is to be understood that the second receiving portion 34 need not be present in accordance with other exemplary embodiments. The receiving portions 18 and 34 may be separated from one another and need not share a common wall. In this regard, the attachment portion 40 having outer perimeter 86 may be distanced so that a space 144 is present between the outer perimeter 120 of the second attachment portion 46. Space 144 may allow the attachment portions 40 and 46 to flex during insertion of the flow control element 16 so that a tighter seal is formed. One or more grips 142 may be included on the lid 14 in order to aid the user in grasping the lid 14 and turning same for removal. The grips 142 can be from 1-4, from 5-8, from 8-15, or up to 20 in number and may be disposed completely about the circumference of the lid 14 and may extend radially outwards from the side of the lid 14.

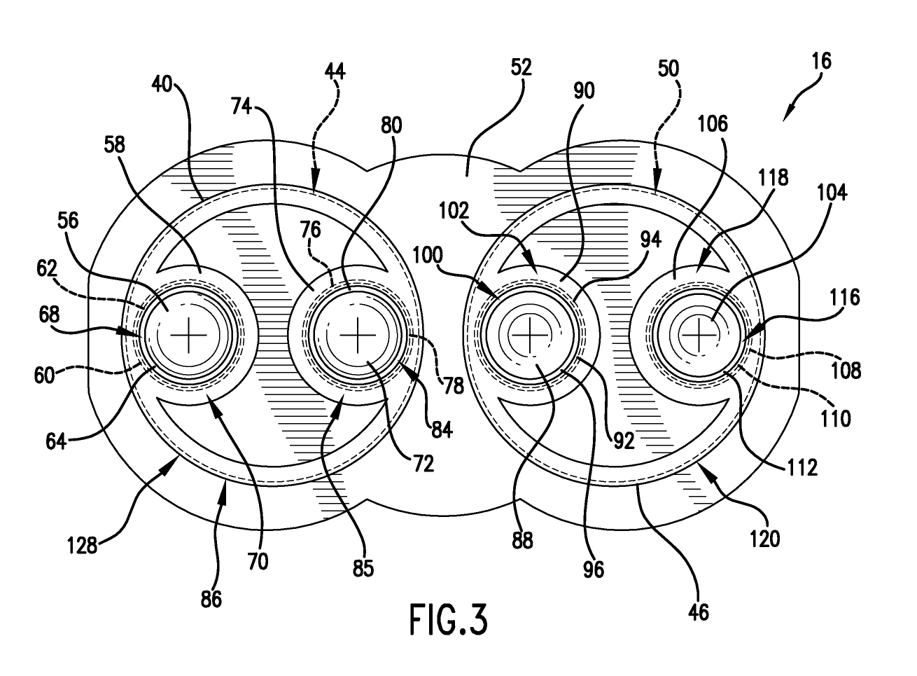

The drinking cup 10 also includes a flow control element 16 that functions to assist the proper flow of beverage and medicine, if present, through the drinking cup 10. With reference to FIGS. 2 and 3, the flow control element 16 has an attachment portion 40 that extends upwards from a base 52. The attachment portion 40 has a circular outer perimeter 86 and is configured for releasable engagement with the receiving portion 18. The attachment portion 40 is shown attached to the receiving portion 18 in FIG. 2. A lid engagement surface 44 is located on the receiving portion 18 and engages the flow control engagement surface 22 of the lid 14. In the exemplary embodiment illustrated, the lid engagement surface 44 is concave in shape. The attachment portion 40 also has a projection 42 that is contiguous with the lid engagement surface 44 and extends therefrom. Projection 42 is received onto the projection receiving surface 20. The projection receiving surface 20 is illustrated as being a step. However, it is to be understood that the projection receiving surface 20 can be variously configured in accordance with other exemplary embodiments.

The entire lid engagement surface 44 from the base 52 to the projection 42 can be concave in shape. However, other arrangements are possible in which only a portion of the lid engagement surface 44 between the base 52 and the projection 42 are concave while the other portion is not concave in shape. The lid engagement surface 44 can be convex, conical, funnel, straight, or variously shaped in accordance with other exemplary embodiments. The projection 42 may extend outward from the lid engagement surface 44 in the radial direction of the attachment portion 40. The projection 42 can extend to such a radial distance that it is located completely radially outward from the entire lid engagement surface 44. In other embodiments, the projection 42 extends radially outward of a majority of the lid engagement surface 44 but not the entire lid engagement surface 44. The projection 42 can extend radially outward from the portion of the lid engagement surface 44 that is contiguous with the projection 42 and hence immediately adjacent the projection 42. In this type of arrangement, the projection 42 may be located radially inwards or at the same position radially with respect to the portion of the lid engagement surface 44 that is adjacent and contiguous with the base 52.

In order to attach the flow control element 16 and the lid 14, the user may align a longitudinal axis 41 of the attachment portion 40 with a longitudinal axis 30 of the receiving portion 18. The user may then push the flow control element 16 and lid 14 so that the projection 42 moves relative to the flow control engagement surface 22. Due to the differences in radial size of these components, the projection 42 will be urged inwards radially as it advances along the flow control engagement surface 22 in a direction generally towards the drinking spout 24. The convex shape of the flow control engagement surface 22 may assist in this insertion as it will facilitate a smooth transition. The attachment portion 40 may be made of a material resilient enough to allow the projection 42 to flex inwardly during this insertion. Once the projection 42 is moved into proximity with the projection receiving surface 20, the radial forces imparted by the flow control engagement surface 22 will be lessened thus allowing the projection 42 to expand outwards in the radial direction and be seated onto the projection receiving surface 20. The projection 42 may snap fit into place once properly positioned. The projection 42 and hence the attachment portion 40 may thus be retained onto the receiving portion 18.

The projection receiving surface 20 and/or the flow control engagement surface 22 may still function to push the attachment portion 40 inwards during this attachment and thus further function to hold the two components together. The convex shape of the flow control engagement surface 22 may be complimentary with the concave shape of the lid engagement surface 44. In this regard, the surfaces 22 and 44 may have the same radii of curvature so that they fit closely against one another during attachment. The entire surfaces 22 and 44 may engage one another, or only portions of the surfaces 22 and 44 may contact one another during attachment in certain exemplary embodiments. The complimentary convex/concave curvature of the surfaces 22 and 44 may likewise function to hold the two components 14 and 16 to one another. The synergistic holding effect of both the projection 42 and surface 20 in combination with the complimentary convex/concave arrangement of surfaces 22 and 44 has been found to effect a surprisingly strong attachment. However, it is to be understood that both of these attachment features need not be present in other arrangements. For example, the projection 42 and surface 20 can be present while the surfaces 22 and 44 are not convex or concave or do not even engage one another.

Once desired, the flow control element 16 and lid 14 can be disengaged from one another through the application of relative force to these components. The user can grasp the base 52 and apply force so as to urge the attachment portion 40 downwards in relation to the receiving portion 18. The projection 42 can be urged out of the projection receiving surface 20 and against the flow control engagement surface 22. This urging will cause the projection 42 to be displaced inwards in the radial direction of the attachment portion 40. The convex shape of the flow control engagement surface 22 will facilitate removal as it acts as a transitional surface to control the radial movement of the projection 42.

The flow control element 16 can also include a second attachment portion 46 that is spaced from the attachment portion 40. The second attachment portion 46 can be seen with reference to FIGS. 2 and 3 and may include a second projection 48 and a second lid engagement surface 50. During attachment, the user can align a longitudinal axis 47 of the second attachment portion 46 to a longitudinal axis 39 of the second receiving portion 34 so that the axes 47 and 39 are coaxial. The second projection 48 and the second lid engagement surface 50 may engage the second projection receiving surface 36 and the second flow control engagement surface 38 during attachment. The second projection 48 and the second lid engagement surface 50 may be configured in a manner similar to that previously discussed with respect to the projection 42 and the lid engagement surface 44 and a repeat of this information is not necessary. As such, the second receiving portion 34 and the second attachment portion 46 function to effectively double the holding power of the flow control element 16 to the lid 14. It is to be understood that the second attachment portion 46 need not be present in other embodiments or can be configured differently from the attachment portion 40 in other arrangements.

The flow control element 16 is present to help direct the flow of beverage and medicine through the drinking cup 10. The flow control element 16 has a valve receiving portion 58 that is used to hold a valve 56. Beverage may be dispensed from the cup body 12 through the valve 56 and into the chamber formed by the drinking spout 24 or likewise at a location between the lid 14 and the flow control element 16. The flow control element 16 has a valve receiving portion 58 that is located within the outer perimeter of the attachment portion 40. The valve receiving portion 58 extends upwards from the base 52 and has a step 62 and a notch 66. The valve 56 rests on the step 62. The valve 56 may be made of a resilient material and can be a one way valve in certain arrangements so that fluid is only capable of moving one way through the valve 56. In yet other arrangements, the valve 56 may be a two way valve so that fluid can move in both directions through the valve 56. A valve retainer 64 is inserted into the valve receiving portion 58 and has a projection 66 that is received with the notch 60 of the valve receiving portion 58. The valve retainer 64 thus functions to hold the valve 56 in place within the valve receiving portion 58. Upon insertion, the upper surface 68 of the valve retainer 64 may be made so as to be flush with the upper surface 70 of the valve receiving portion 58. The valve retainer 64 can be arranged so that a flange is not present such that the valve retainer 64 does not cover a portion of the upper surface 70 and such that the projection 66 extends completely radially beyond any other portion of the valve retainer 64. The outer side surface of the valve retainer 64 may thus have a single, constant dimension in the radial direction except for the projection 66.

With reference now to FIG. 3, the flow control element 16 may have a member that forms both a portion of the valve receiving portion 58 and the attachment portion 40. In other exemplary embodiments, the valve receiving portion 58 can be completely separate from the attachment portion 40. The valve receiving portion 58 may be located within the outer perimeter 86 and may form the highest vertical portion of the flow control element 16. A second valve 72 may be included and can he held onto the flow control element 16 inside of a second valve receiving portion 74. FIG. 2 shows the second valve 72 as being associated with the medicine cup 124 to allow medicine to flow from the medicine cup 124 and into the portion of the drinking cup 10 between the lid 14 and the flow control element 16 to subsequently mix therein with the beverage. The valve 72 may prevent fluid from moving back from this portion into the medicine cup 124. As such, the second valve 72 can be a one way valve in that fluid or air is not allowed to revert back into the medicine cup 124 and can only move one way across the valve 72. The second valve receiving portion 74 may include a notch 76, step 78 and an upper surface 85. Likewise, a second valve retainer 80 may be included to retain the second valve 72 to the second valve receiving portion 74 and can have a projection 82 and an upper surface 84. When assembled, the upper surface 84 can be flush with the upper surface 85. The second valve 72, second valve receiving portion 74, and the second valve retainer 80 and their associated features can be configured in an identical manner as the valve 56, valve receiving portion 58, and valve retainer 64 as previously discussed and a repeat of this information is not necessary.

The flow control element 16 may also include features that allow air to flow into the drinking cup 10 as beverage or medicine is dispensed from the drinking cup 10. Venting of the drinking cup 10 allows for easier dispensing of fluid from the drinking cup 10. The second attachment portion 46 has an outer perimeter 120 that surrounds both a third valve receiving portion 90 and a fourth valve receiving portion 106. The third valve 88 is used to allow air from the vent holes 132 to be transferred into the medicine cup 124 to facilitate transfer of medicine from the medicine cup 124 and prevent a vacuum from forming therein and preventing or hindering dispensing. The third valve 88 may be a one way valve so that medicine is not capable of being transferred across the third valve 88 and into the location illustrated between the lid 14 and the flow control element 16. The third valve receiving portion 90 can include a notch 92 and a step 94, and a third valve retainer 96 may be present with a projection 98. These elements can be configured in a similar manner as those previously discussed with respect to the valve 56, valve receiving portion 58, and valve retainer 64 and a repeat of this information is not necessary. Further, when assembled the upper surface 100 of the third valve retainer 96 can be flush with the upper surface 102 of the third valve receiving portion 90.

A fourth valve 104 may be included in the drinking cup 10 and can be used to allow air from the vent holes 132 to be transferred into the cup body 12 so that beverage in the cup body 12 can be more easily dispensed therefrom through valve 56. The fourth valve 104 may be a one way valve to prevent beverage from being dispensed through the fourth valve 104 and into the location between the lid 14 and the flow control element 16. The fourth valve receiving portion 106 may include a notch 108 and a step 110. A fourth valve retainer 112 may likewise be present to effect attachment of the fourth valve 104 to the fourth valve receiving portion 106 and can include a projection 114. The fourth valve 104, fourth valve receiving portion 106, and fourth valve retainer 112 can be arranged in a manner similar to the valve 56, valve receiving portion 58, and valve retainer 64 as discussed above and a repeat of this information is not necessary. The upper surface 116 of the fourth valve retainer 112 can be flush with the upper surface 118 of the fourth valve receiving portion 106. In accordance with certain exemplary embodiments, the upper surfaces 70, 85, 102 and 118 may be located at the same vertical height as one another and may be the highest vertical surfaces of the flow control element 16. The upper surfaces 68, 84, 100 and 116 may be located at the same vertical height and at a vertical height below the surfaces 70, 85, 102 and 118 or may be located flush and hence as the same vertical height as surfaces 70, 85, 102 and 108. In other exemplary embodiments, the surfaces 68, 84, 100 and 116 may be located at the same vertical height as one another and may be at a vertical height above the upper surfaces 70, 85, 102, and 118 and hence may be the highest vertical surfaces of the flow control element 16.

The flow control element 16 may include a medicine cup receiving portion 54 that extends downwards from the base 52 so as to be on the opposite side of the base 52 as the attachment portion 40 and the second attachment portion 46. The medicine cup receiving portion 54 can include internal threading that engages external threading of the medicine cup 124 so as to effect attachment. The user may unscrew the medicine cup 124 to detach same from the medicine cup receiving portion 54 when desired to fill the medicine cup 124 or to clean the medicine cup 124. Although shown as being releasably attached through the use of a threaded connection, the medicine cup 124 can be releasably attached to the flow control element 16 through the use of a projection and concave/convex surfaces in a manner as previously discussed with respect to the receiving portion 18 and the attachment portion 40.

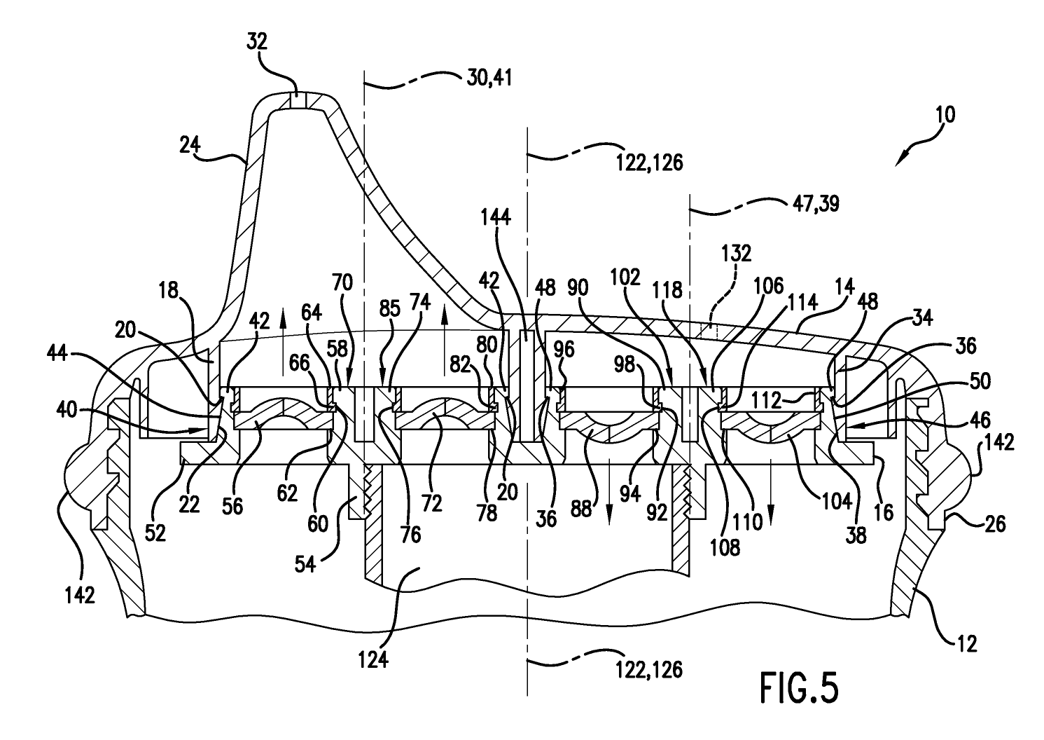

An alternative exemplary embodiment of the drinking cup 10 is illustrated in FIG. 5. Here, the attachment portion 40 is arranged so that the lid engagement surface 44 is cone shaped and has a consistent angular orientation from the base 52 to the projection 42. The lid engagement surface 44 thus does not have a concave or a convex shape but rather has a cone shaped surface that has the same line of inclination throughout its entire length. The projection 42 extends outwards radially from the lid engagement surface 44 so as to extend radially beyond at least a portion of the lid engagement surface 44. In other arrangements, the projection 42 may extend radially beyond the entire lid engagement surface 44 or a majority of the lid engagement surface 44. The flow control engagement surface 22 has a funnel shape and does not have a convex or a concave shape. The flow control engagement surface 22 has a shape that is complimentary to the lid engagement surface 44 such that the flow control engagement surface 22 engages the lid engagement surface 44 along its entire length when the flow control element 16 is attached to the lid 14. The bottom surface of the receiving portion 18 engages the top surface of the base 52. Further, the projection 42 engages a projection receiving surface 20 when the flow control element 16 is attached. Attachment is effected in a similar manner as previously discussed in that the flow control element 16 is inserted into the lid 14 and the projection 42 is urged radially inwards as it moves upwards across the flow control engagement surface 22. Once the projection 42 encounters the projection receiving surface 20, the radially inward force on the projection 42 ceases and the projection 42 expands or snaps outwards onto the flow control engagement surface 22. The attachment portion 40 can be secured through either the engagement with the projection 42 to the projection receiving surface 20, or through the engagement between the cone shaped lid engagement surface 44 and the funnel shaped flow control engagement surface 22, or through the combination of these features. When removal is desired, the user can urge the flow control element 16 apart from the lid 14 so that the projection 42 is forced radially inwards upon being urged vertically downwards and against the flow control engagement surface 22.

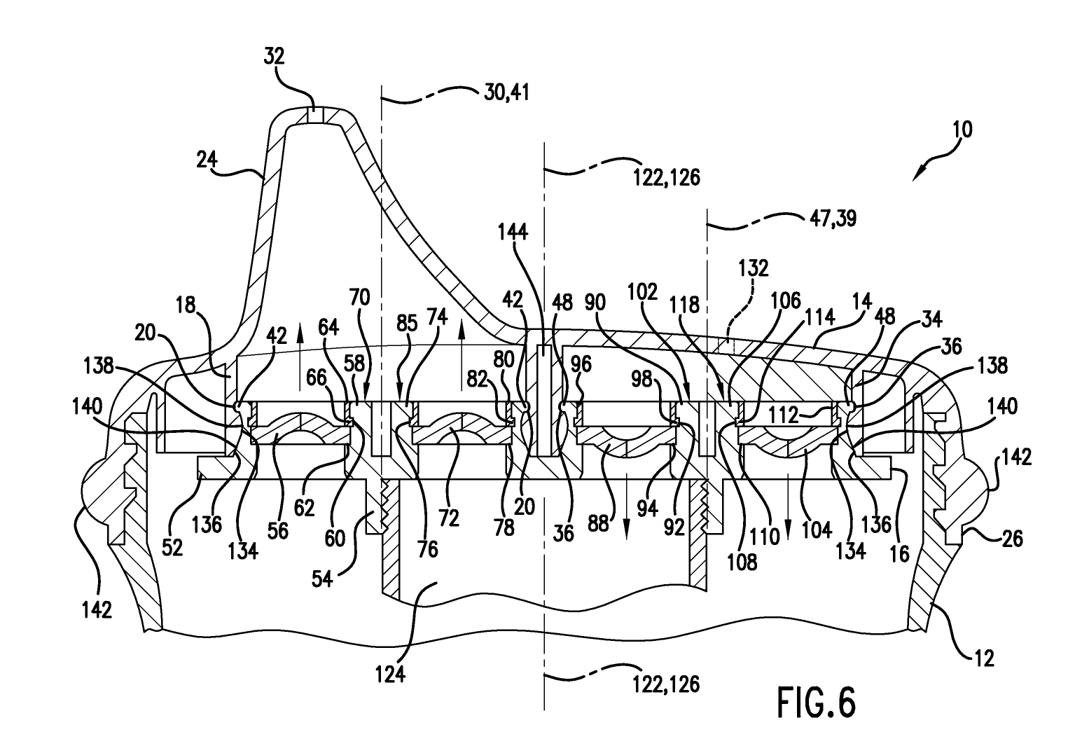

Another alternative exemplary embodiment is illustrated in FIG. 6. Here, the lid engagement surface 44 has a conical portion 136 that is contiguous with and extends from the base 52, and a concave portion 134 that is contiguous with the conical portion 136 and extends therefrom to the projection 42. The flow control engagement surface has a funnel portion 140 that is complimentary with the conical portion 136 and that engages the conical portion 136 during attachment. The funnel portion 140 extends from the bottom of the receiving portion 18. The flow control engagement surface 22 also includes a convex portion 138 that is contiguous with the funnel portion 140 and that engages the concave portion 134 during attachment. The concave portion 134 and convex portion 138 have shapes that are complimentary to one another and thus fully engage one another during attachment.

The projection receiving surface 20 is a notch into which the projection 42 is inserted during attachment. The notch 20 thus extends around more than 180° of the outer surface of the projection 42 that has a circular cross-sectional shape. The notch 20 may thus engage a portion of the bottom, side, and top surfaces of the projection 42. The projection receiving surface 20 can be sized so as to tightly receive the projection 42 such that the projection 42 snap fits into the notch 20. Disengagement of the flow control device 16 may be effected in a similar manner as previously discussed.

The variously exemplary embodiments presented show the lid engagement surface 44 and the projection 42 on an outer surface 128 of the attachment portion 40, and the flow control engagement surface 22 and the projection receiving surface 20 on the inner surface 130 of the receiving portion 18. As such, to effect attachment, the outer surface 128 of the attachment portion 40 engages the inner surface 130 of the receiving portion 18. However, it is to be understood that other exemplary embodiments are possible in which the inner surface of the attachment portion 40 engages the outer surface of the receiving portion 18 to effect releasable attachment. In such arrangements, the aforementioned surfaces may have a convex or concave shape and may or may not include a projection to effect the releasable attachment. Further, although shown as being on the attachment portion 40, the projection 42 may be on the receiving portion 18 in other arrangements and the projection receiving surface 20 can be located on the attachment portion 40. Likewise, the projection 42 need not be located at the upper portion of the attachment portion 40 in other exemplary embodiments. For example, the projection 42 may be located proximate the base 52 or may be located intermediate the base 52 and the upper surface of the attachment portion 40 in accordance with other exemplary embodiments. In certain exemplary embodiments, both the flow control engagement surface 22 and the lid engagement surface 44 are both straight surfaces and are not convex, concave, conical, or funnel shaped. The flow control element 16 may be attached through the use of the projection 42 received onto the projection receiving surface 20 with minimal or no frictional engagement between the flow control engagement surface 22 and the lid engagement surface 44.

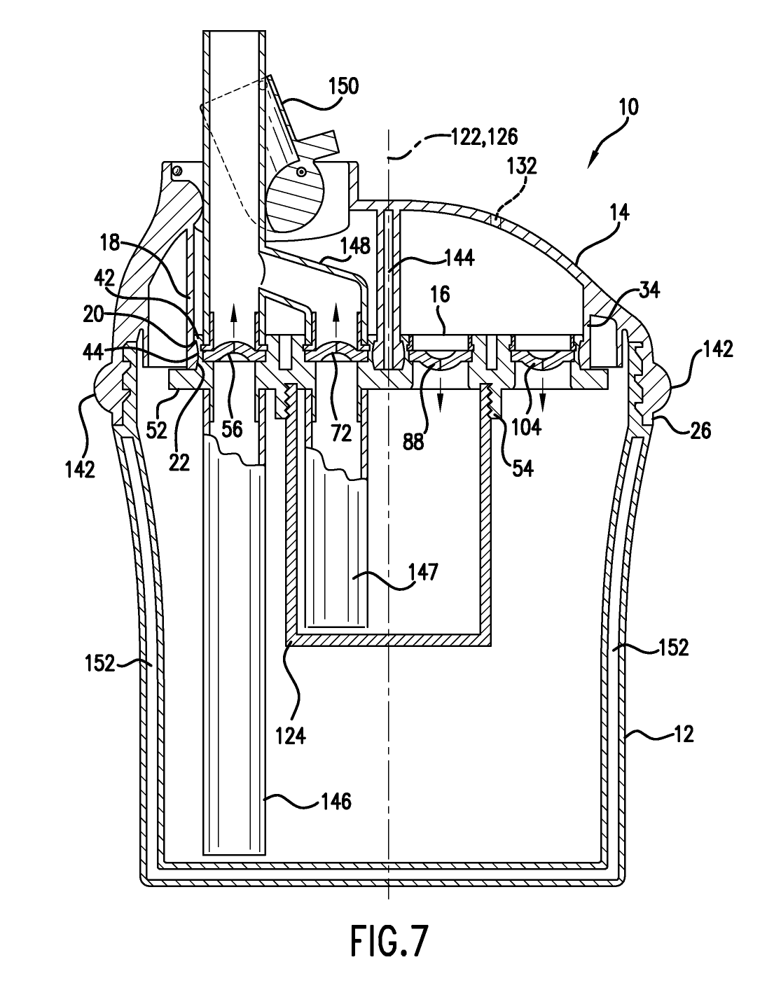

An alternative exemplary embodiment of the drinking cup 10 is disclosed in FIG. 7. Here, the cup body 12 is double walled so that a space 152 is present between the two walls of the cup body 12. Space 152 functions as an insulator to inhibit heat flow through the cup body 12. The space 152 may be completely empty or may include some type of additional insulation in accordance with other embodiments. The arrangement in FIG. 7 has a first straw 146 that extends from the flow control element 16 below the valve 56. The flow control element 16 may have projections extending therefrom around which the first straw 146 is seated and retained via a frictional fit. The first straw 146 is used to pull fluid from the cup body 12 and then through the valve 56. A second straw 147 is located in the medicine cup 124 and is likewise attached to the flow control element 16. The second straw 147 may be frictionally fit into a projection of the flow control element 16. In other arrangements, the first and second straws 146 and 147 may be retained by being forced inside of a projection of the flow control element 16 rather than around such projections. Medicine from the medicine cup 124 is pulled through the second straw 147 and through the second valve 72. A third straw 148 likewise extends from the flow control element 16 and is located above the valves 56 and 72 so that flow exiting the valves 56 and 72 flow into the third straw 148. The third straw 148 is branched so that fluid exiting valve 56 mixes with fluid exiting second valve 72. The third straw 148 may be a single component or may be made of multiple components that are joined together. The third straw 148 may be arranged so that it is frictionally fit around a projection of the flow control element 16 at the valve 56 and frictionally fit around a projection of the flow control element 16 at the valve 72. It is to be understood that various arrangements are possible for effecting attachment of the straws 146, 147 and 148 to the flow control element 16 and that the disclosed arrangements are only exemplary.

A straw closing mechanism 150 is included on the lid 14 and functions to close the third straw 148 when moved from an open to a closed position. The straw closing mechanism 150 in the closed position completely covers the tip of the third straw 148 and may in some arrangements function to pinch the tip of the third straw 148. In this regard, a ridge or bump may be provided on the lid 14 and the turning of the straw closing mechanism 150 will cause the third straw 148 to be moved over the bump and hence pinched between the bump and the straw closing mechanism 150. This pinching may function to both seal the third straw 148 and pull the third straw 148 into the cavity of the straw closing mechanism 150.

Further, although shown as employing four valves 56, 72, 88, and 104, it is to be understood that any number of valves may be included in other embodiments. For example, the drinking cup 10 may include but a single valve, from 2-5 valves, from 4-6 valves, or up to 10 valves in accordance with other exemplary embodiments. The drinking cup 10 may be provided with one or more handles to assist the user in holding the drinking cup 10 during use. The handle may extend from the cup body 12 and may be variously configured.

In all of the variously disclosed embodiments, the flow control element 16 may include one or more valves, 56, 72, 88, and/or 104, one or more various valve retainers 64, 80, 96, and/or 112, and/or one or more projections. The valve retainers and/or projections may be used to attach and engage and hold one or more straws 146, 147 and/or 148. In other embodiments, other components may be used to attach one or more straws 146, 147 and/or 148 to the flow control element 16.

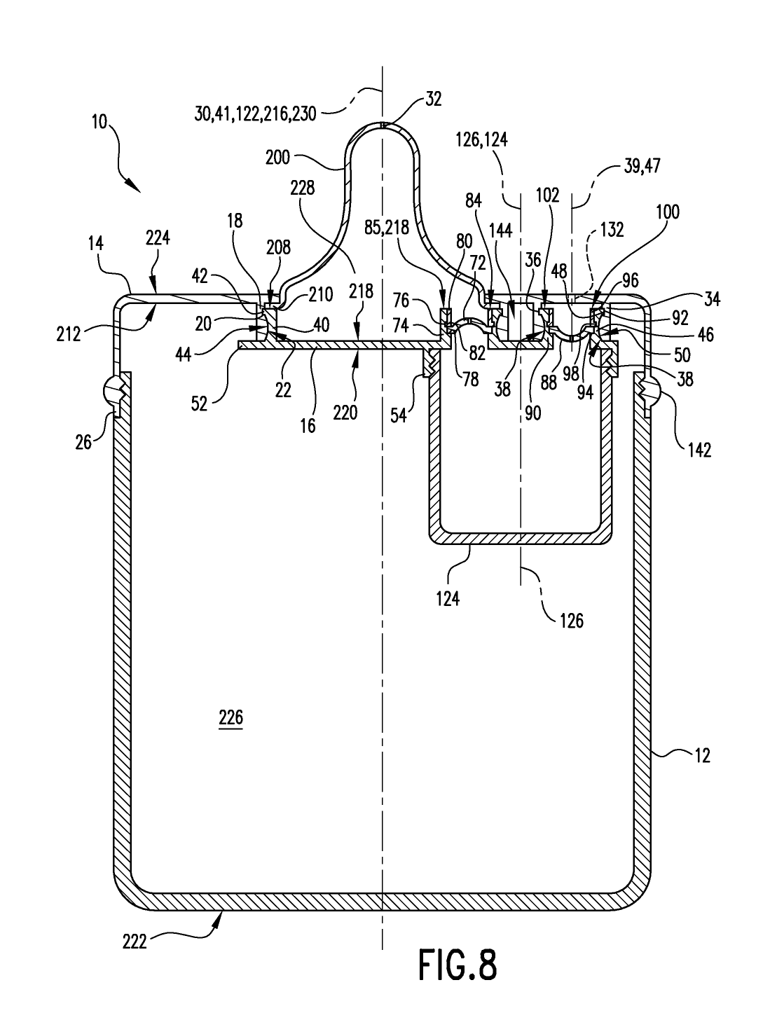

Another exemplary embodiment of the drinking cup 10 is illustrated with reference to FIG. 8. The drinking cup 10 includes a nipple 200 from which combined fluid and medicine may be dispensed. The nipple 200 can be made of a flexible material and can be deformed during drinking by the user of the drinking cup 10. The material making up the nipple 200 can be resilient enough so as to bounce back into its original shape after the removal of force applied by the user after drinking. The nipple 200 may have a longitudinal axis 216 that may be at the center of the nipple 200 and that may represent a point of symmetry about which the nipple 200 can revolve. A slit or other opening can be defined through the nipple 200 at its surface that intersects the longitudinal axis 216. The longitudinal axis 216 can be coaxial with the longitudinal axis 122 of the cup body 12. In other exemplary embodiments, the longitudinal axes 216 and 122 can be parallel to one another but not coaxial with one another such that the longitudinal axis 216 is spaced some distance from the longitudinal axis 122 in the radial direction.

The drinking cup 10 includes a medicine cup 124 that holds medicine and from which the medicine is dispensed. The longitudinal axis 126 of the medicine cup 124 is parallel to the longitudinal axes 122 and 216 but is not coaxial with the longitudinal axes 122 and 216. In other versions of the drinking cup 10, the longitudinal axis 126 is offset from the longitudinal axis 122 but is not parallel with the longitudinal axis 122. The longitudinal axis 126 may be offset from the longitudinal axes 122 and 216 in the radial direction so that the medicine cup 124 is offset from the cup body 12. Although offset from the longitudinal axis 122, the medicine cup 124 is still located completely within a perimeter 202 of the cup body 12 such that the medicine cup 124 is still located within a cavity 226 of the medicine cup 124. The medicine cup 124 may engage the inner wall of the cup body 12 in some instances or may be spaced some distance from the inner wall of the cup body 12.

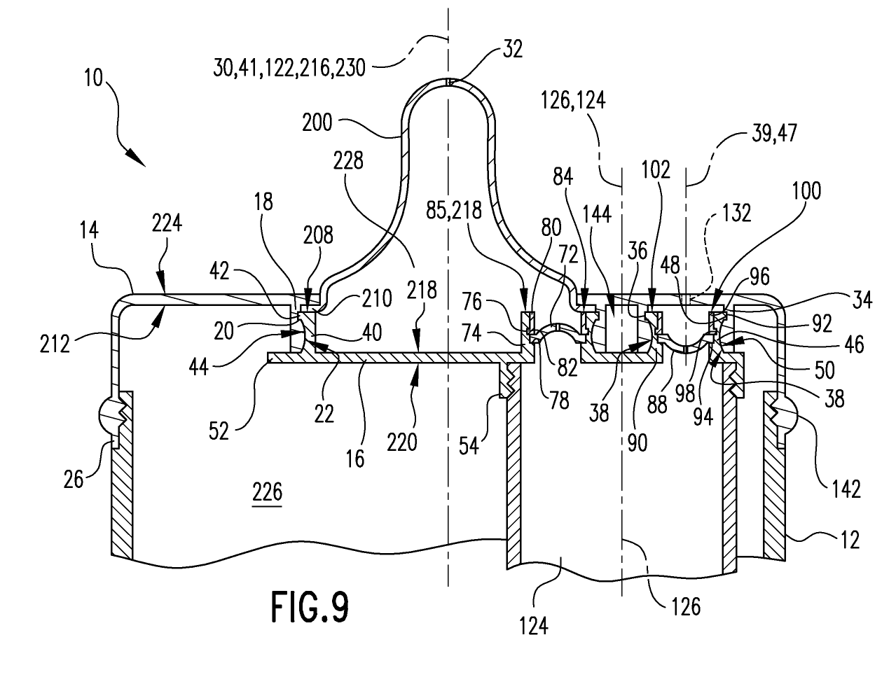

Reference is now made to FIG. 9 which is a close-up view of the drinking cup 10 of FIG. 8 that shows the area of connection between the nipple 200, lid 14, flow control element 16, and medicine cup 124. The cross-section is taken through valves 72 and 88. The nipple 200 has a flange 210 on its outer perimeter. The flange 210 may be made of the same material as the rest of the nipple 200 and may be symmetrical in shape about the longitudinal axis 216 of the nipple 200. The lid 14 has a lower surface 212 that is the surface that faces towards the cavity 226 of the cup body 12 when the lid 14 is attached to the cup body 12. An upper surface 224 of the lid 14 is disposed oppositely to the lower surface 212 and is the outer surface of the lid 14 when the lid 14 is attached to the cup body 12. The nipple 200 is arranged with respect to the lid 14 so that the flange 210 engages the lower surface 212.

The flow control element 16 has an upper surface 218 that faces towards the lower surface 212 when the lid 14 is attached to the cup body 12. The attachment portion 40 of the flow control element 16 has an upper surface 208. The upper surface 208 is thus a portion of the upper surface 218 of the entire flow control element 16. The upper surface 208 engages the flange 210 on the lower side of the flange 210 which is opposite to the upper side of the flange 210 engaged by the lower surface 14. The flange 210 is compressed between the surfaces 212 and 208 so that the flange 210 and the rest of the nipple 200 is attached to the lid 14. The compression force may be due to the engagement of the flow control element 16 with the lid 14 in which the flow control element 16 is urged towards the lid 14 or is snapped into place thus moving closer to the lower surface 212 to form a space smaller than the width of the flange 210 to function to compress the flange 210. It is to be understood, however, that various means of attaching the flange 210 or other portions of the nipple 200 to the lid 18, flow control element 16, or cup body 12 are possible to effect attachment of the nipple 200 to the drinking cup 10.

The attachment portion 40 may have a circular shape and can have a longitudinal axis 41 that is coaxial with the longitudinal axes 122 and 216. The attachment portion 40 may be attached to the lid 14 in manners similar to those previously discussed. As shown, the receiving portion 18 has a projection receiving surface 20 and a convex shaped flow control engagement surface 22 that extends from the projection receiving surface 20. The attachment portion 40 has a concave shaped lid engagement surface 44 that engages the flow control engagement surface 22. The attachment portion 40 also has a projection 42 that engages the projection receiving surface 20, and the attachment portion 40 snaps into the receiving portion 18 to effect attachment of the lid 14 to the flow control element 16. The base 52 extends across the flow control element 16 to prevent fluid in the cavity 226 from exiting the cavity 226 and into the nipple 200.

Second valve 72 is shown in the closed position in FIG. 9 and is included in the flow control element 16 at the attachment portion 40. The second valve 72 may be received within a second valve receiving portion 74 of the attachment portion 40. The second valve 72 may be attached to the attachment portion 40 in the same manner as previously discussed. The valve retainer 80 can snap into a notch 76 to secure the second valve 72 onto the attachment portion 40. The second valve 72 is within the outer perimeter 86 of the attachment portion 40. In other embodiments, the second valve 72 can be located at any position within the outer perimeter 86 or at any position outside of the outer perimeter 86. Medicine from the medicine cup 124 flows out of the second valve 72 and into the nipple 200 where it can mix with fluid and be dispensed out of the nipple 200. In other arrangements, the medicine may not mix with the fluid from the cup body 12 in the nipple 200 but may mix with the fluid at some point after dispensing from the nipple 200.

The third valve 88 is shown in FIG. 9 and air from outside of the lid 14 flows through the vent holes 132 and then through the third valve 88 and into the medicine cup 124. The third valve 88 may be secured to the second attachment portion 46 through the use of a third valve receiving portion 90 of the flow control element 16 that has a notch 92 and a step 94. The third valve retainer 96 has a projection 98 that is received in the notch 92 and that functions to hold the third valve 88 to the third valve receiving portion 90 in a manner as previously described. The second attachment portion 46 of the flow control element 18 has a second engagement surface 50 that is concave in shape and has a second projection 48. A second receiving portion 34 of the lid 14 includes a second projection receiving surface 36 that engages the second projection 48, and a convex second flow control engagement surface 38 that engages the second engagement surface 50. The second attachment portion 46 may thus be retained to the second receiving portion 34 in the same manner as that previously described. The third valve 88 is outside of the outer perimeter 86 of the first attachment portion 40.

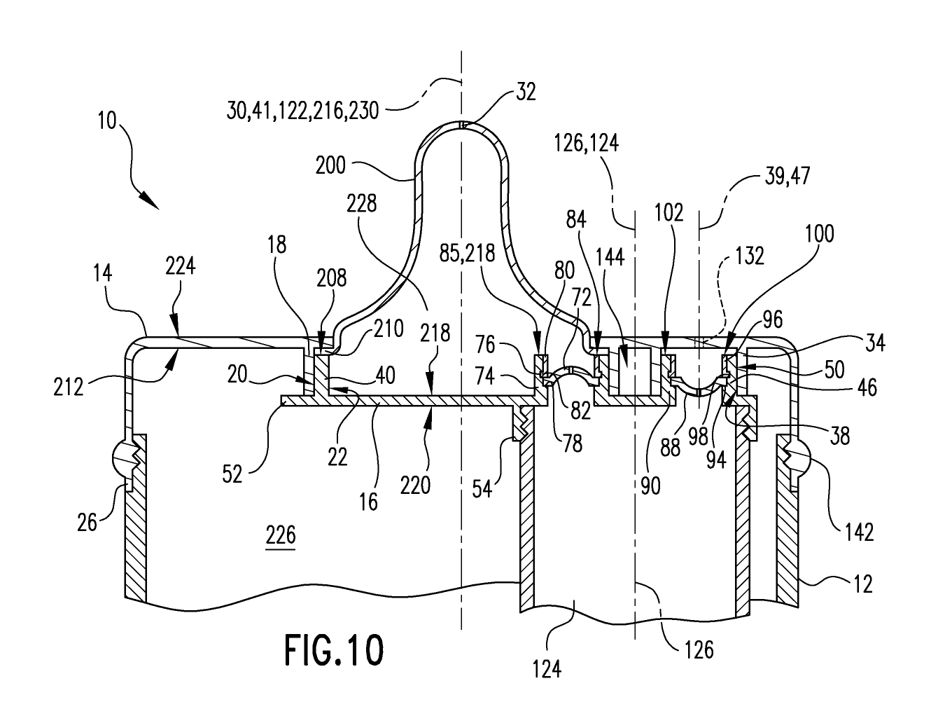

FIG. 10 is an alternative exemplary embodiment of the drinking cup 10 that is the same as the arrangement in FIGS. 8 and 9 except for the structure that effects attachment of the flow control element 16 to the lid 14. In the embodiment of FIG. 10, the first attachment portion 40 has a straight lid engagement surface 44 instead of a concave lid engagement surface 44, and the flow control engagement surface 22 of the receiving portion 18 is likewise straight instead of convex in shape. The projection receiving surface 20 and the projection 42 are likewise absent from the embodiment in FIG. 10. The lid engagement surface 44 is frictionally received into the flow control engagement surface 22 in order to retain the attachment portion 40 to the receiving portion 18 and hence retain the flow control element 18 onto the lid 14. When separation is desired, the user can apply force to remove these two components 14 and 16 so that the frictional resistance is overcome and the lid engagement surface 44 slides relative to the flow control engagement surface 22.

The attachment of the second attachment portion 46 to the second receiving portion 34 is also different than the arrangement of FIGS. 8 and 9. The second attachment portion 46 has a straight second lid engagement surface 50 instead of a concave second lid engagement surface 50, and the second flow control engagement surface 38 of the second receiving portion 34 is likewise straight instead of convex in shape. The second projection receiving surface 36 and the second projection 48 are likewise absent from the embodiment in FIG. 10. The second lid engagement surface 50 is frictionally received into the second flow control engagement surface 38 in order to retain the second attachment portion 46 to the second receiving portion 34 and hence retain the flow control element 18 onto the lid 14. When separation is desired, the user can again apply force to remove these two components 14 and 16 so that the frictional resistance is overcome and the second lid engagement surface 50 slides relative to the flow control engagement surface 38. As such it is to be understood that releasable engagement between the flow control element 16 and the lid 14 can be effected in a variety of manners and that those disclosed are only exemplary.

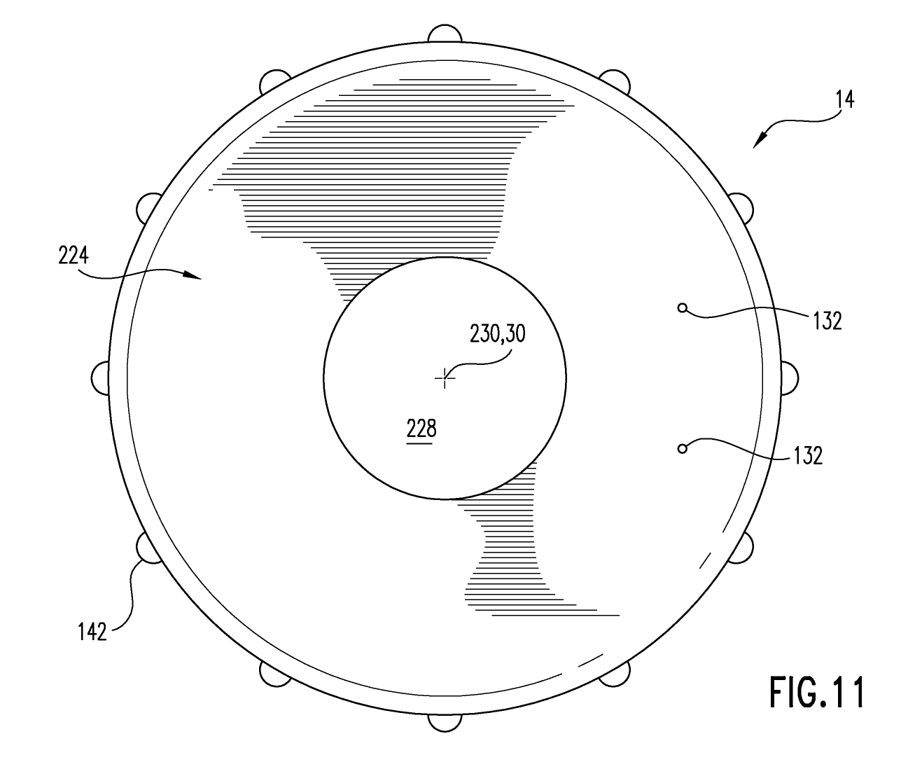

A top view of a lid 14 is shown with reference to FIG. 11. The lid 14 includes a series of grips 142 about its perimeter to aid in grasping and turning the lid 14 relative to the cup body 12 for attachment and detachment. An opening 228 is defined completely through the lid 14 from the upper surface 224 to the lower surface 212. The opening 228 is circular in shape and has a longitudinal axis 230 that is at the center of the lid 14. The opening 228 is for receipt of the nipple 200 and the longitudinal axis 230 is coaxial with the longitudinal axes 41, 122 and 216 when assembled. A pair of vent holes 132 are defined completely through the lid 14 from the upper surface 224 to the lower surface 212 and are disposed radially from the longitudinal axis 230 and are thus spaced from the opening 228.

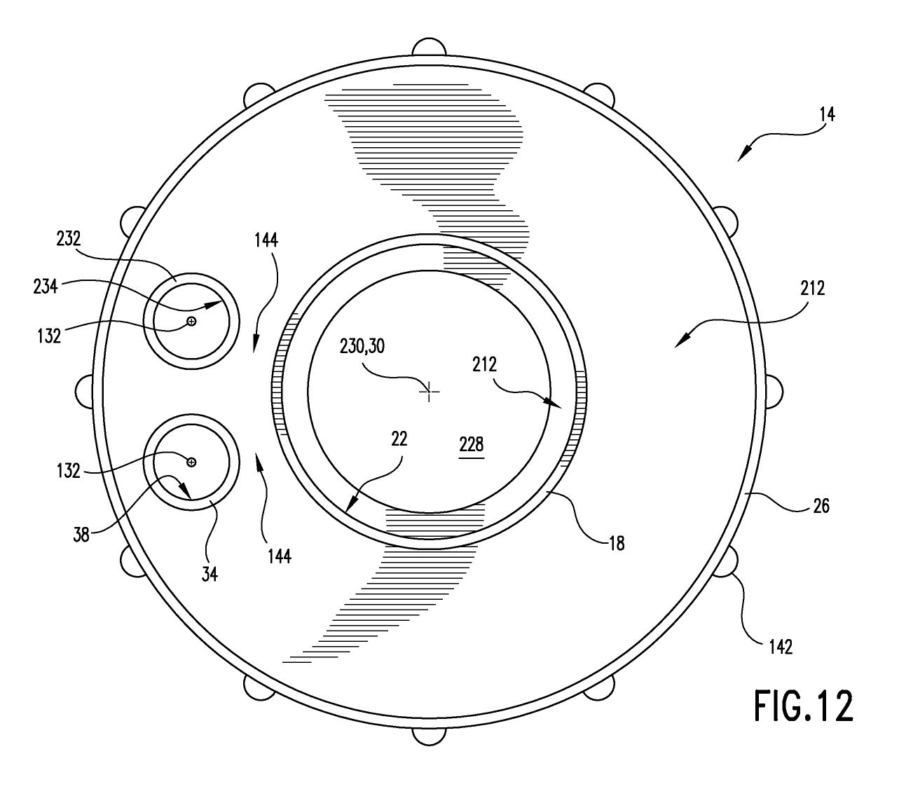

A bottom view of the lid 14 of FIG. 11 is shown in FIG. 12. The first receiving portion 18 surrounds the perimeter of the opening 228. The second receiving portion 34 is spaced radially from the longitudinal axis 230 and the first receiving portion 18 so that a space 144 is present between elements 18 and 34.

In other exemplary embodiments the receiving portions 18 and 34 can engage one another so that they are not separated by space 144. The vent hole 132 can be completely contained within the perimeter of the second receiving portion 34. A third receiving portion 232 that has a third flow control engagement surface 234 that can be convex in shape may be located on the lower surface 212 of the lid 14. The third receiving portion 232 can be configured in a manner identical to that of the second receiving portion 34. The vent hole 132 may be located within the perimeter of the third receiving portion 232. The third receiving portion 232 can be spaced from the longitudinal axis 230 in the radial direction so that a space 144 is present between the third receiving portion 232 and the first receiving portion 18. The third receiving portion 232 is also spaced from the second receiving portion 34 although they could engage one another in other embodiments. Further, in other arrangements the third receiving portion 232 may engage the first receiving portion 18.

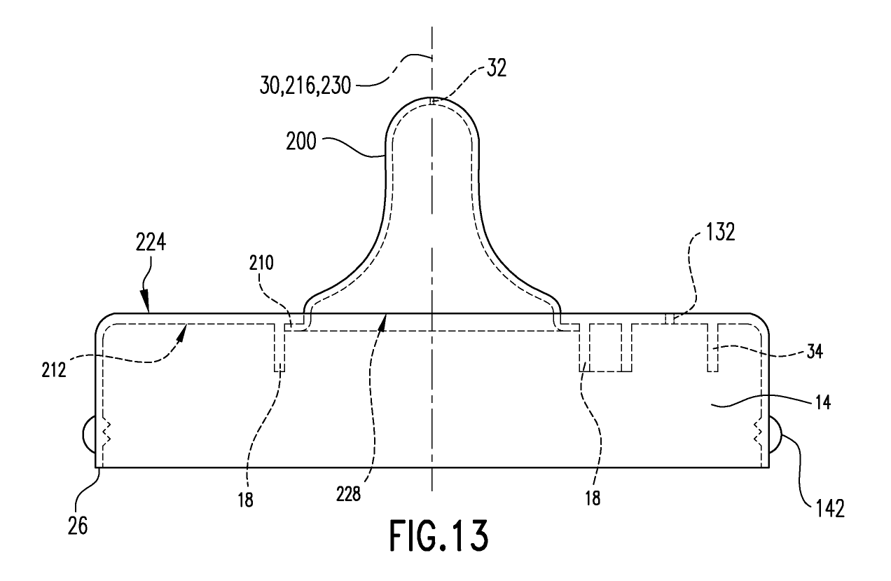

FIG. 13 is a side view of the nipple 200 engaged with the lid 14. The nipple 200 extends through the opening 228 so that part of the nipple 200 is outside of the lid 14 with the remaining portion inside of the lid 14. The flange 210 engages the lower surface 212 of the lid 14. The flange 210 can be completely contained within the perimeter of the first receiving portion 18 of the lid 14 so that the flange 18 does not engage the second receiving portion 34. The flange 210 may be frictionally fit within the first receiving portion 18 so that it engages the first receiving portion 18 and is held therein through a frictional engagement. Added pressure from the flow control element 18 when attached may function to apply additional holding force to the flange 210 to hold the flange 210 to the lid 14. However, it is to be understood that the frictional fit of the flange 210 to the first receiving portion 18 may be sufficient to hold these two parts into engagement with one another.

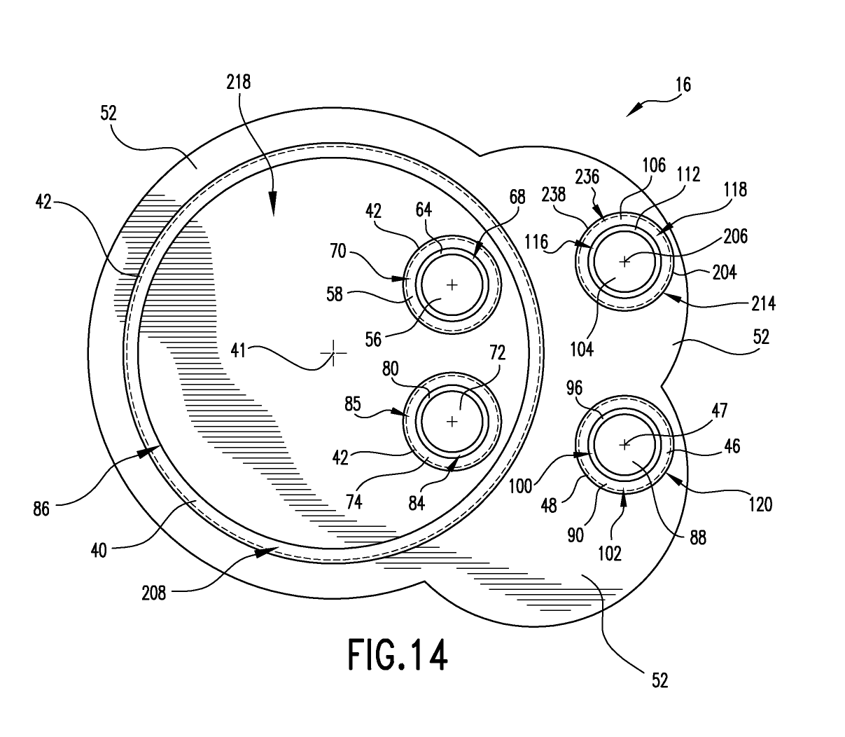

A top view of the flow control element 16 is shown in FIG. 14. The first valve 56 and the second valve 72 are located within the outer perimeter 86 of the first attachment portion 40. Fluid from the cup body 12 flows out of the first valve 56 from the lower surface 220 to and past the upper surface 218. Medicine from the medicine cup 124 flows out of the second valve 72 from the lower surface 220 to and past the upper surface 218. The base 52 functions to close off and prevent fluid flow within the outer perimeter 86 except for through the valves 56 and 72. The first valve 56 may be retained by a first valve receiving portion 58 of the first attachment portion 40. A valve retainer 64 can be used to help secure the first valve 56 to the first valve receiving portion 58. The first valve receiving portion 58 may be configured in a manner identical to that of the second valve receiving portion 74 previously described in order to retain the first valve 56 and a repeat of this information is not necessary. Although shown engaging and being a part of the first attachment portion 40, the first valve receiving portion 58 may be spaced away from the first attachment portion 40 so that it does not engage the first attachment portion 40 in other exemplary embodiments. The first valve receiving portion 58 may still be located within the outer perimeter 86 which is circular and has the longitudinal axis 41 at its center. Fluid from the cup body 12 exits through the first valve 56 and into the nipple 200.

The second attachment portion 46 extends upwards from the base 52 and includes the third valve receiving portion 90 that has an upper surface 102 that is flat and extends about the longitudinal axis 47. The third valve 88 is retained at the third valve receiving portion 90 and is located within the outer perimeter 120 of the second attachment portion 46. The outer perimeter 120 is completely outside of the outer perimeter 86 and no portions of outer perimeters 86 and 120 overlap. Also extending upwards from the base 52 is a third attachment portion 204 with a fourth valve receiving portion 106 that receives the fourth valve 104 that is retained by the fourth valve retainer 112. A projection 238 is located at the fourth valve receiving portion 106. The fourth valve receiving portion 106 can be configured in the same manner as previously described with respect to the first, second and third valve receiving portions 58, 74, and 90 and a repeat of this information is not necessary. Air flows through the vent holes 132 of the lid 14 and through the fourth valve 104 and into the cup body 12.

The third attachment portion 204 has a longitudinal axis 206 about which the fourth valve receiving portion 106 and fourth valve 104 are symmetric. An upper surface 236 of the third attachment portion 204 may be flat and may extend in a circle completely around the longitudinal axis 206. The upper surface 236 may be located a distance above the base 52 such that the upper surface 236, the upper surface 102, upper surface 70 and upper surface 85 are all located within the same plane as one another. The entire fourth valve 104 is retained within an outer perimeter 214 of the third attachment portion 204, and no part of the outer perimeter 214 overlaps any part of the outer perimeter 86 or outer perimeter 120. The longitudinal axes 206 and 47 along with longitudinal axes of the first valve 56 and the second valve 72 can be oriented with respect to one another so that they form the corners of a rectangle.

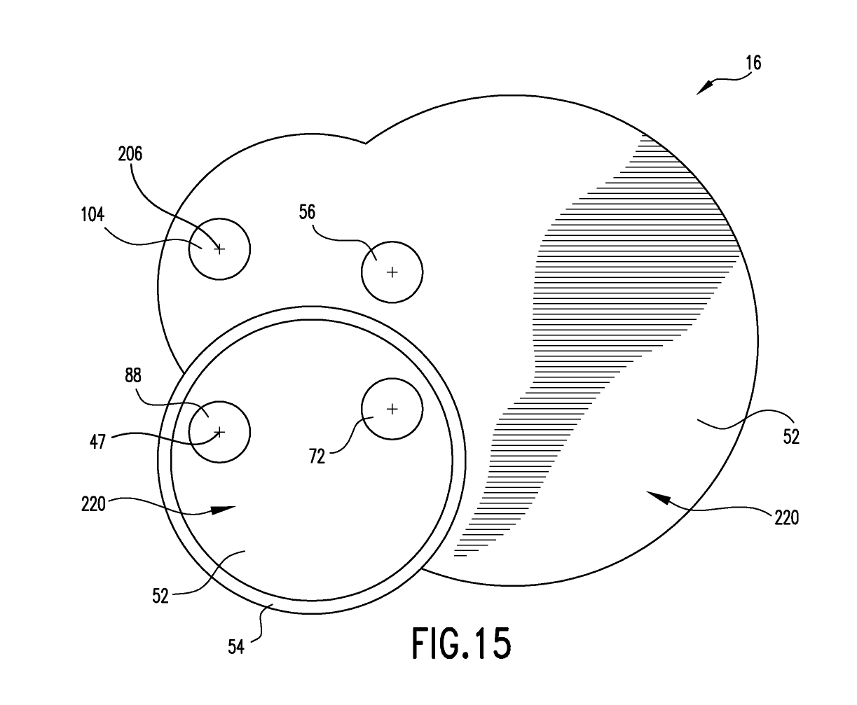

A bottom view of the flow control element 16 is shown in FIG. 15. The medicine cup receiving portion 54 extends from the lower surface 220 and is circular in shape. The second valve 72 and the third valve 88 are located within the perimeter of the medicine cup receiving portion 54 and the first and fourth valves 56 and 104 are located outside of the perimeter of the medicine cup receiving portion 54. Although not visible in FIG. 15, the second and third valve receiving portions 74 and 90 are located within the perimeter of the medicine cup receiving portion 54, and the first and fourth valve receiving portions 58 and 106 are located outside of the perimeter of the medicine cup receiving portion 54. The base 52 is closed along the entire perimeter of the flow control element 16 to prevent any fluid or medicine from moving from the lower surface 220 past the upper surface 218 and thus through the flow control element 16 except at the valves 56, 72, 88 and 104.

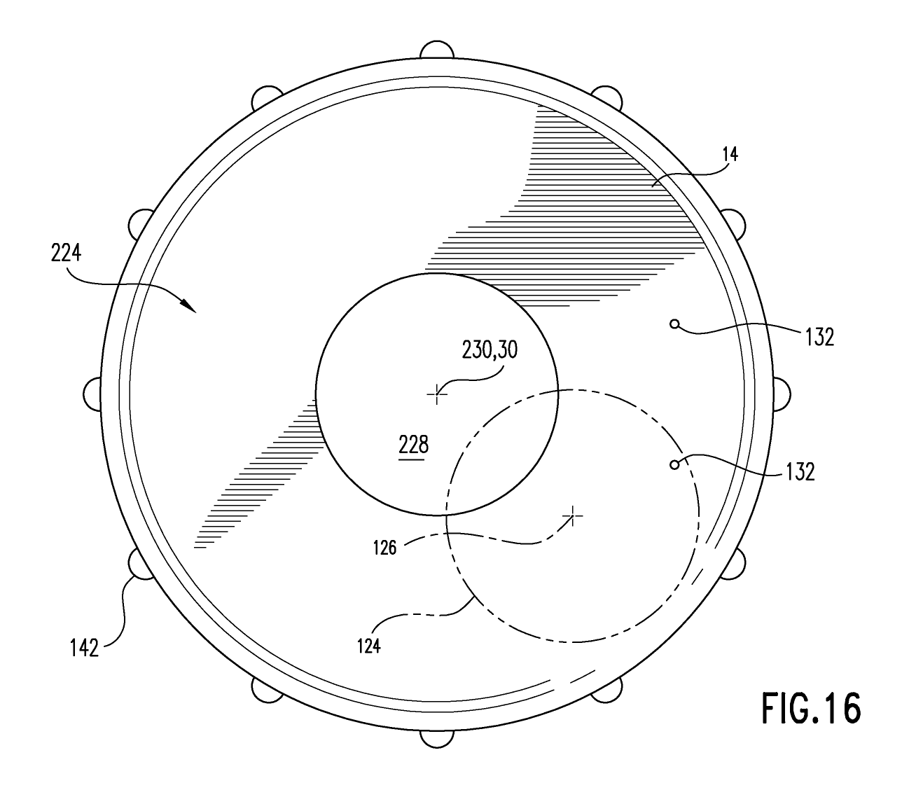

FIG. 16 shows a top view of the lid 14 that is the same as that disclosed with respect to FIG. 11. The location of the medicine cup 124 relative to the lid 14 is shown in FIG. 16. The medicine cup 124 is located below the lid 14 and is offset from the longitudinal axis 230 of the opening 228. The longitudinal axis 230 is at the center of the lid 14 such that the lid 14 is symmetrical about the longitudinal axis 230. The longitudinal axis 126 of the medicine cup 124 is offset in the radial direction from the longitudinal axis 230 such that the longitudinal axis 126 is not located within the perimeter of the opening 228. However, in other exemplary embodiments, the longitudinal axis 126 is in fact located within the perimeter of the opening 228. One of the vent holes 132 may be located within the perimeter of the medicine cup 124. The medicine cup 124 is thus offset from the center of the lid 14 and is not symmetrically placed with respect to the longitudinal axis 230.

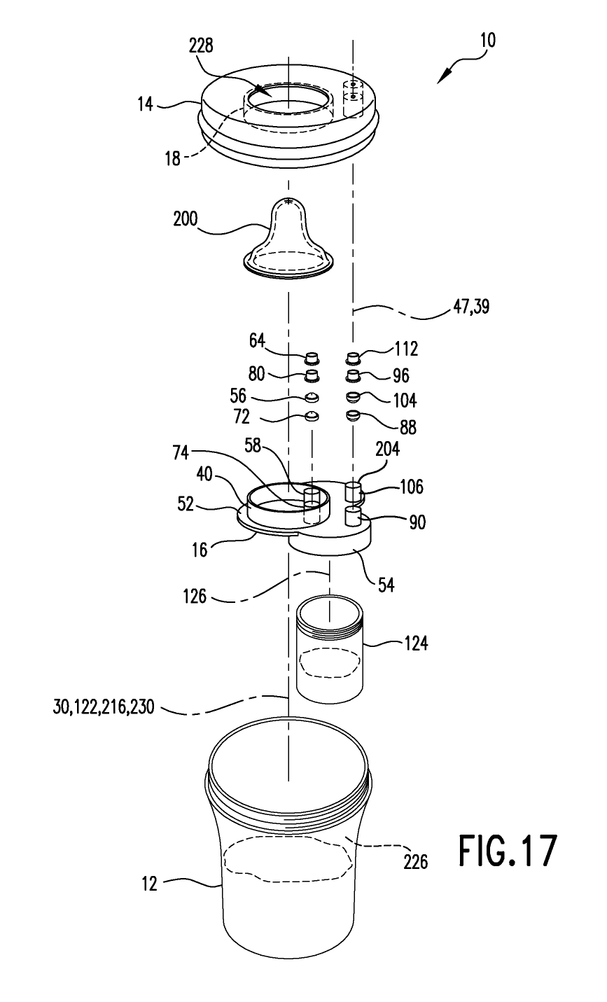

An exploded perspective view of the drinking cup 10 is shown in FIG. 17 to further illustrate the design. The entire medicine cup 124 is located with the perimeter 202 of the cup body 12. All of the valves 56, 72, 88 and 104 are located within the perimeter 202 as well. The entire medicine cup 124 can be located within the cavity 226 of the cup body 12, or only a portion of the medicine cup 124 may be within the cavity 226 in accordance with different exemplary embodiments.

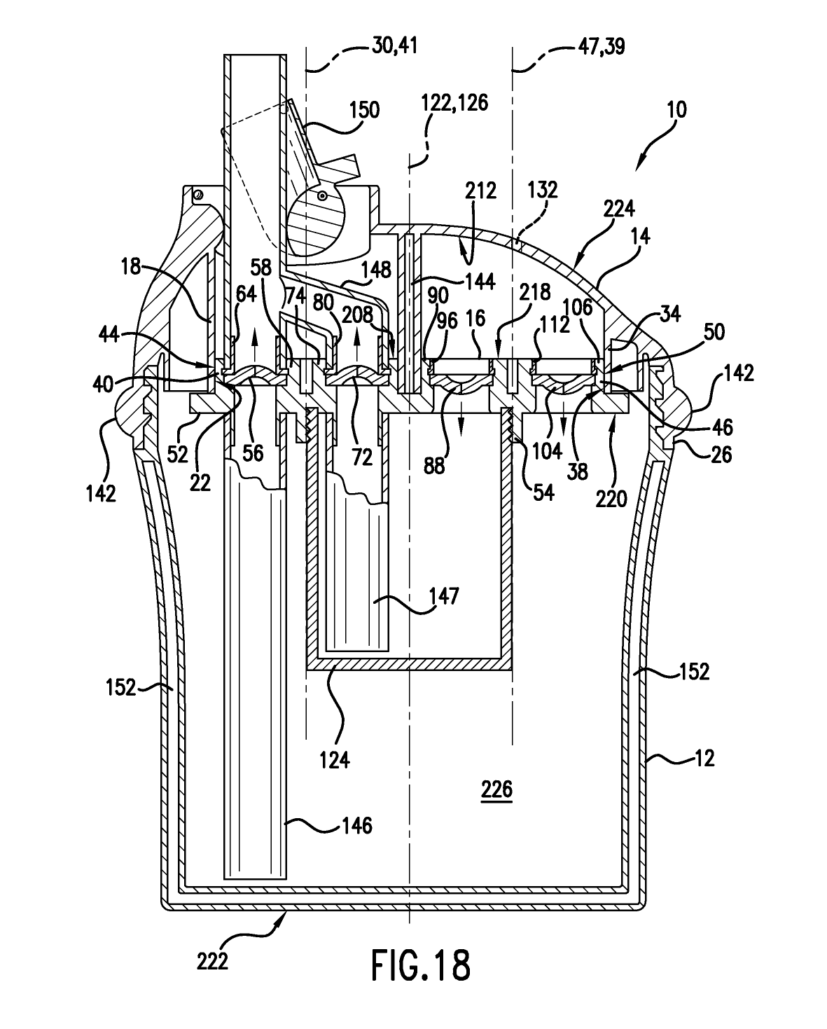

An alternative exemplary embodiment of the drinking cup 10 is disclosed in FIG. 18 in which the drinking cup 10 does not include the nipple 200. The drinking cup 10 is arranged in the same manner as that of FIG. 7 except for the type of connection between the flow control element 16 and the lid 14. In the FIG. 18 arrangement, the first attachment portion 40 has a straight lid engagement surface 44 instead of a concave lid engagement surface 44, and the flow control engagement surface 22 of the receiving portion 18 is likewise straight instead of convex in shape. The projection receiving surface 20 and the projection 42 are likewise absent from the embodiment in FIG. 18. The lid engagement surface 44 is frictionally received into the flow control engagement surface 22 in order to retain the attachment portion 40 to the receiving portion 18 and hence retain the flow control element 18 onto the lid 14. When separation is desired, the user can apply force to remove these two components 14 and 16 so that the frictional resistance is overcome and the lid engagement surface 44 slides relative to the flow control engagement surface 22.

The attachment of the second attachment portion 46 to the second receiving portion 34 is also different than the arrangement of FIG. 7. The second attachment portion 46 has a straight second lid engagement surface 50 instead of a concave second lid engagement surface 50, and the second flow control engagement surface 38 of the second receiving portion 34 is likewise straight instead of convex in shape. It is to be understood that when described as being “straight” in the present application the component in question has a straight cross-sectional shape and is cylindrical in shape when viewed in a perspective view. The second projection receiving surface 36 and the second projection 48 are likewise absent from the embodiment in FIG. 18. The second lid engagement surface 50 is frictionally received into the second flow control engagement surface 38 in order to retain the second attachment portion 46 to the second receiving portion 34 and hence retain the flow control element 18 onto the lid 14. When separation is desired, the user can again apply force to remove these two components 14 and 16 so that the frictional resistance is overcome and the second lid engagement surface 50 slides relative to the flow control engagement surface 38. As such it is to be understood that releasable engagement between the flow control element 16 and the lid 14 can be effected in a variety of manners and that those disclosed are only exemplary.

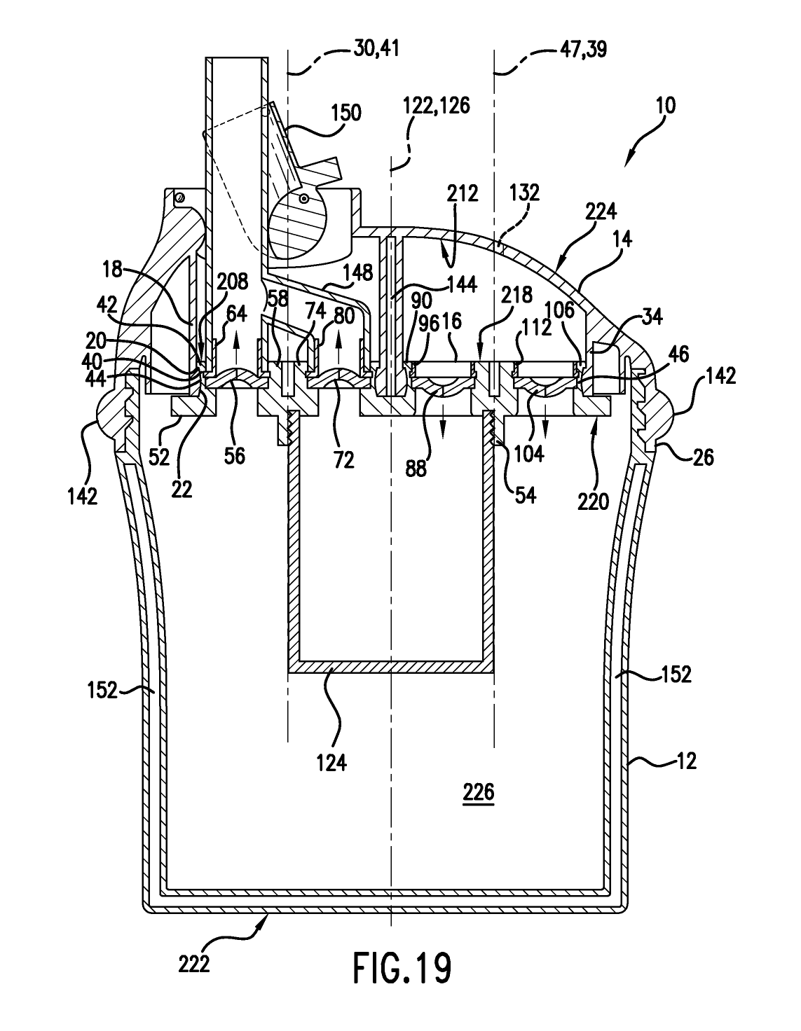

Another exemplary embodiment of the drinking cup 10 is disclosed in FIG. 19. Here, the engagement between the flow control element 16 and the receiving portions 18 and 34 of the lid 14 is releasable and is the same as that disclosed and described with reference to the exemplary embodiment of FIG. 7. However, the straws 146 and 147 are not present. Instead, no straw is present between the lower surface 220 of the flow control element 16 and the bottom surface 222 of the cup body 12. Straw 148 is present and is located between the upper surface 218 of the flow control element 16 and the lower surface 212 of the lid :14 and in fact extends through the lid 14 for engagement by the lips of the user when in the open position. Aside from the lack of the straws 146 and 147, the drinking cup 10 is the same as that disclosed in FIG. 7. Medicine may move through the medicine cup 124 and past second valve 72 and into the drinking straw 148, and fluid may move through the cavity 226 of the cup body 12 and past the first valve 56 and into the drinking straw 148 in a similar manner to effect dispensing of the medicine and fluid. It is to be understood that other arrangements are possible in which the drinking straw 148 is configured differently from that explicitly disclosed in FIG. 19.

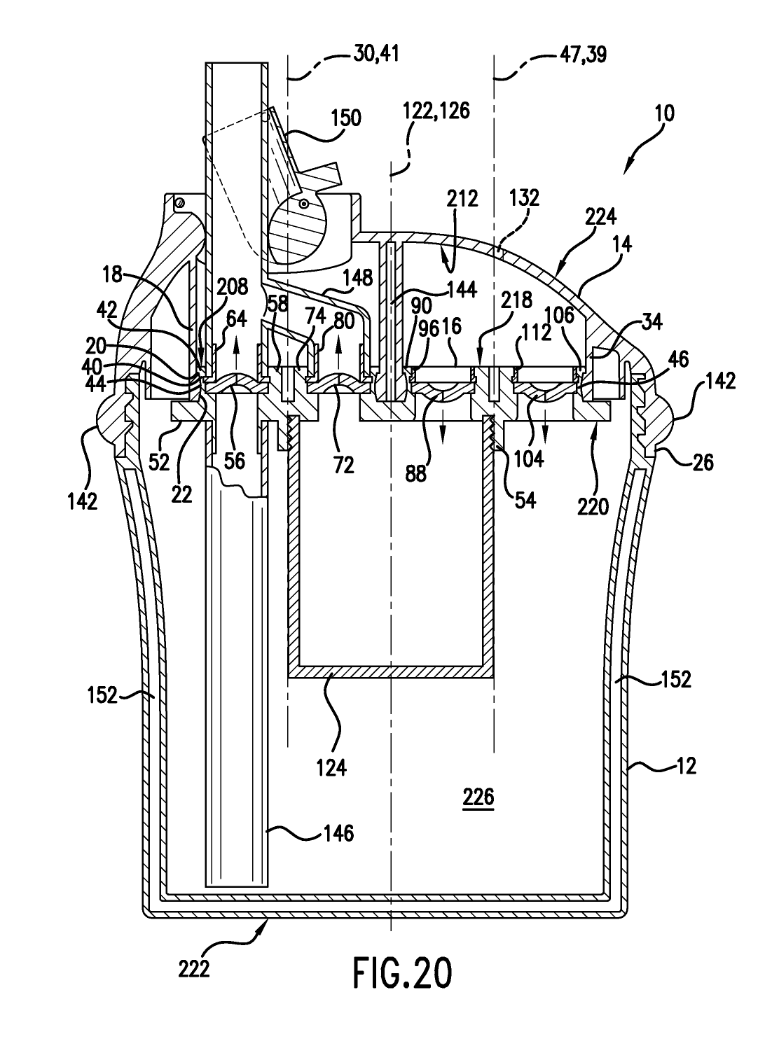

FIG. 20 shows another exemplary embodiment of the drinking straw 10 that is the same as that in FIG. 19 except for the fact that straw 146 is present and is located between the lower surface 220 and the bottom surface 222. The straw 146 is in communication with the first valve 56 so that fluid can move through the cavity 226 and into the straw 146 and through the first valve 56 and into the straw 148. The straw 146 is located within the cavity 226 and is inside of the perimeter 202 of the cup body 12. The straw 146 is not located within the medicine cup 124.

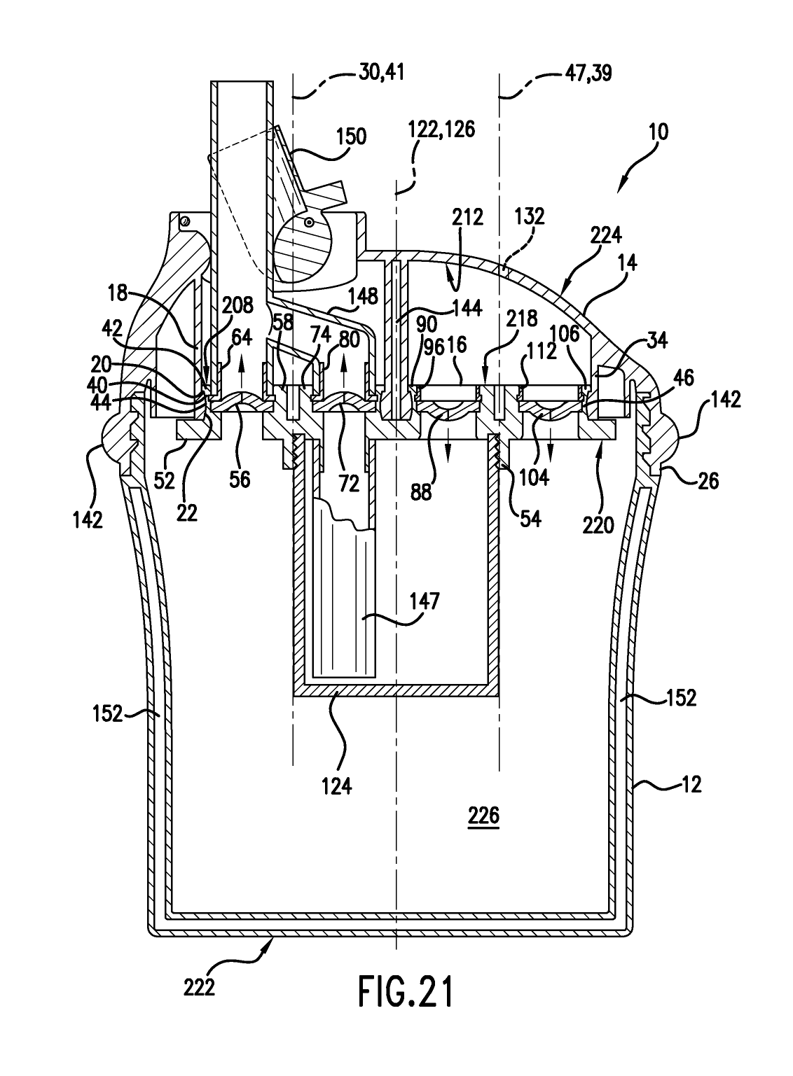

Another version of the drinking cup 10 is disclosed in FIG. 21 that is similar to that of FIG. 20 except for the fact that the straw 146 is removed and the straw 147 is added. Straw 147 is located between the bottom surface 222 and the lower surface 220 of the flow control element 16. Medicine flows from the medicine cup 124 and into the straw 147 and past the second valve 72 and into the straw 148. The straw 147 is located within the perimeter of the medicine cup 124 and does not engage the fluid in the cavity 226. It is therefore the case that various versions of the drinking cup 10 exist in which any one of, or any two of, all of the straws 146, 147 and/or 148 can be present within the drinking cup 10 although not all of these variations are shown in the figures. Further, although the embodiments in FIGS. 19-20 include the attachment between the lid 14 and the flow control element 16 that is the same as that of FIG. 7, others are possible such as the one disclosed in FIG. 18 between components 14 and 16. Also, other exemplary embodiments are possible in which the connection between components 14 and 16 can be variously configured and it is to be understood that the disclosed versions are only for sake of example.

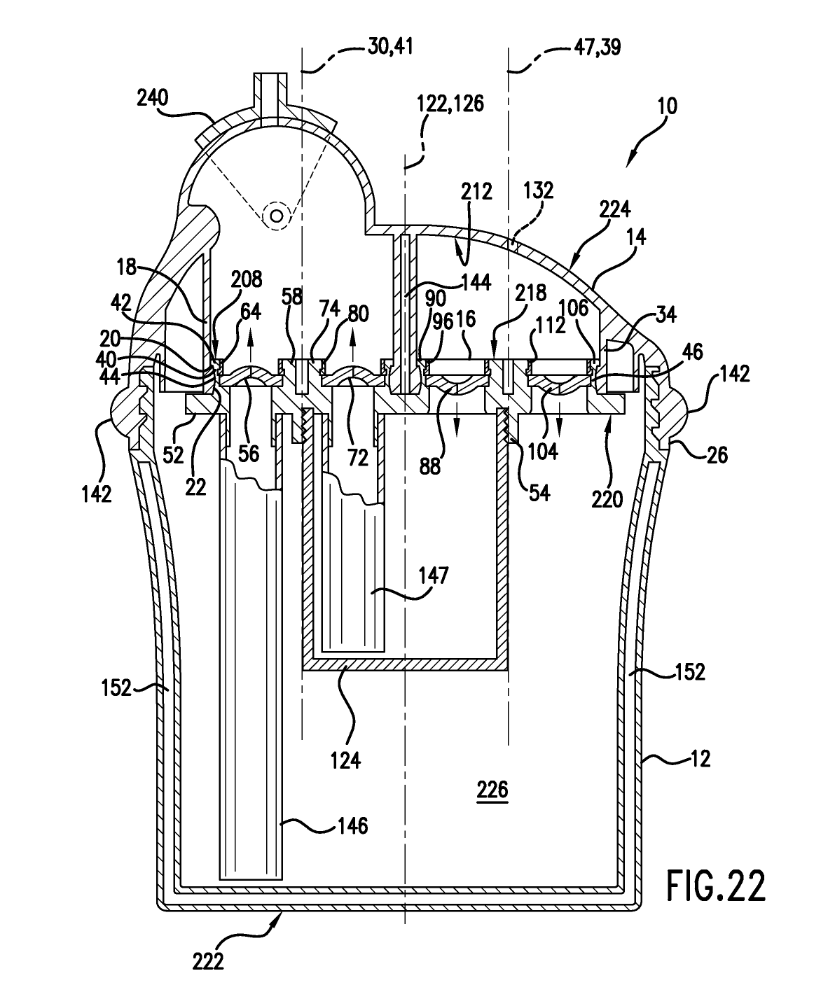

FIG. 22 discloses an exemplary embodiment of the drinking cup 10 in which straws 146 and 147 are present and are between the lower surface 220 and the bottom surface 222. However, there is no straw present between the upper surface 218 of the flow control element 16 and the lid 14. Straw 148 is not present in this arrangement. Instead of the use of the straw clamping mechanism 150 previously shown and described a flip top spout 240 is included on the lid 14. The flip top spout 240 is pivotally attached to the lid and is movable between a closed position in which fluid and medicine is prevented from exiting through the lid 14 by moving from the lower surface 212 through the lid 14 and past the upper surface 224. The flip top spout 240 is shown in the open position in FIG. 22 and the fluid and medicine may flow through the flip top spout 240 to exit the lid 14 and be dispensed to the user. The only location of dispensing of the fluid and medicine may be through the flip top spout 240 and the rest of the lid 14 can be completely sealed. The fluid may exit valve 56 and the medicine may exit second valve 72 and they can mix in the space between the upper surface 218 and the lower surface 212 before being transferred through the flip top spout 240. The drinking cup 10 of FIG. 22 has a releasable connection between the flow control element 16 and the lid 14 that is the same as that of FIG. 7, although it may be varied as previously described.

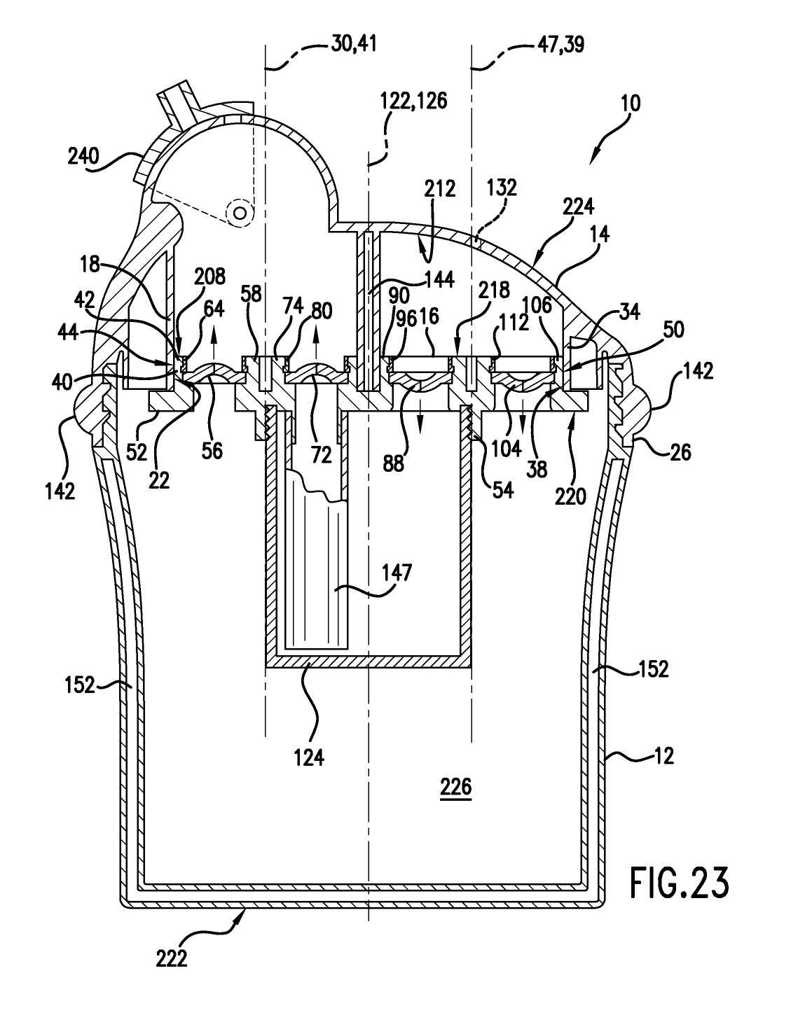

Another version of the drinking cup 10 is shown with reference to FIG. 23 which is the same as the version in FIG. 22 with the exception that straw 146 is not present. As such, there is no straw present that is between the lower surface 220 and the bottom surface 222 that is outside of the perimeter of the medicine cup 124. The straw 147 is present and functions as previously described. The flip top spout 240 is shown in the closed position in FIG. 23 in which is it pivoted from the position illustrated in FIG. 22. In the closed position, fluid and medicine are not capable of moving through the flip top spout 240 and out of the lid 14. The fluid and medicine are contained within the space between the lower surface 212 and the upper surface 218 and are thus held within the lid 14. The flip top spout 240 in the closed position effects a seal of the lid 14 so that fluid and medicine are prevented from exiting through the lid 14 when in the closed position. The flip top spout 240 can be pivoted by the user to the position shown in FIG. 22 in order to allow fluid and medicine to be removed through the lid 14. The releasable attachment between the flow control element 16 and the lid 14 is the same as that disclosed in FIG. 18, although it can be varied in accordance with other exemplary embodiments.

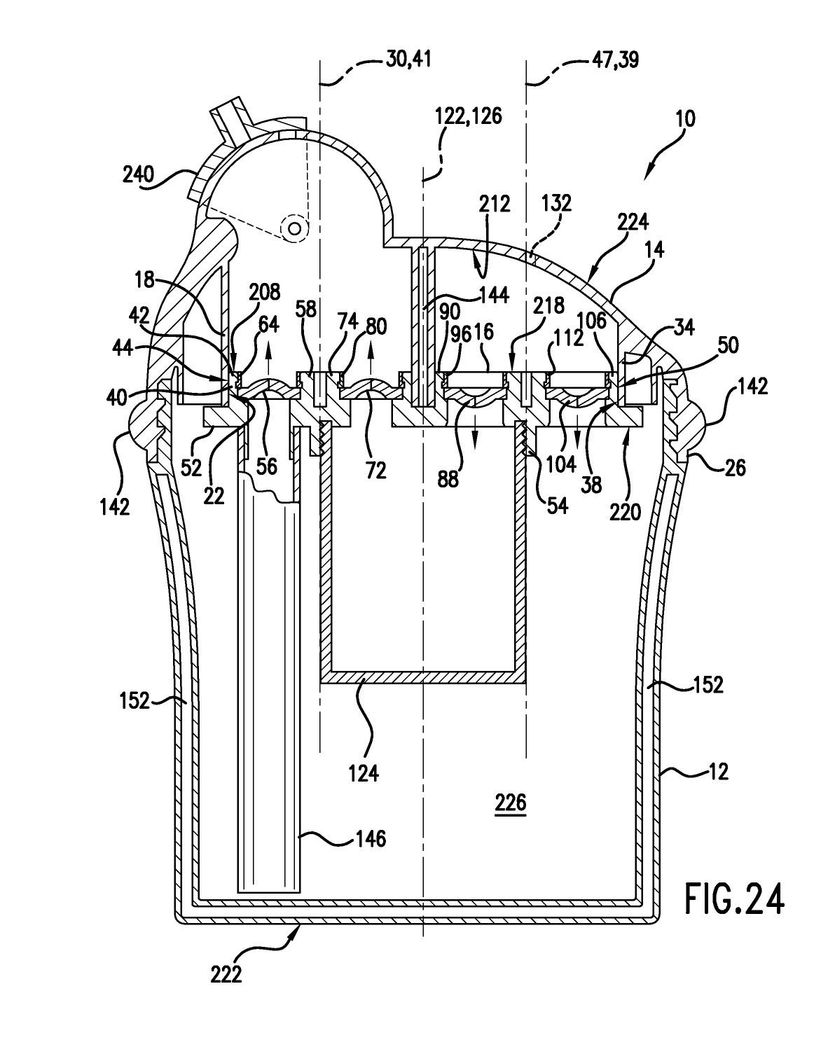

Another exemplary embodiment is shown in FIG. 24 that is configured in a manner the same as that of FIG. 23 with the exception that straw 146 is present and straw 147 is not present. As such, there is no straw present between the lower surface 220 and the bottom surface 222 that is also within the perimeter of the medicine cup 124. There is a straw (146) present between the lower surface 220 and the bottom surface 222 that is outside of the perimeter of the medicine cup 124.

It is to be understood that the embodiments in FIGS. 21-24 can include any type of attachment between the lid 14 and the flow control element 16, for example those previously disclosed. Further, in other embodiments these components 14 and 16 need not be releasable from one another. It is to be understood that the disclosed embodiments are for sake of example and that others are possible.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

What is claimed:

1. A drinking cup, comprising:
a nipple;
a lid that engages the nipple;
a cup body that engages the lid;
a flow control element; and
a medicine cup into which medicine is disposed, wherein the medicine in the medicine cup moves through the flow control element and then through the nipple.

2. The drinking cup as set forth in claim 1, wherein the flow control element has a valve, wherein the medicine in the medicine cup moves through the valve when moving through the flow control element.

3. The drinking cup as set forth in claim 1, wherein the cup body has a longitudinal axis, and wherein the medicine cup has a longitudinal axis that is parallel with the longitudinal axis of the cup body but is not coaxial with the longitudinal axis of the cup body.

4. The drinking cup as set forth in claim 1, wherein the nipple has a longitudinal axis that is coaxial with the longitudinal axis of the cup body, wherein the longitudinal axis of the nipple is parallel with the longitudinal axis of the medicine cup but is not coaxial with the longitudinal axis of the medicine cup.

5. The drinking cup as set forth in claim 4, wherein the medicine cup is located within a perimeter of the cup body.

6. The drinking cup as set forth in claim 1, wherein the flow control element has an upper surface and wherein the lid has a lower surface, wherein the nipple has a flange, wherein the flange engages the lower surface of the lid and wherein the flange engages the upper surface of the flow control element.

7. The drinking cup as set forth in claim 1, wherein the flow control element has a first valve, a second valve, a third valve, and a fourth valve, wherein fluid is disposed in the cup body and is outside of the medicine cup, wherein the flow control element has a first attachment portion that has an outer perimeter and that engages the lid, wherein the first valve and the second valve are located within the outer perimeter of the first attachment portion and wherein the third valve and the fourth valve are located outside of the outer perimeter of the first attachment portion;
wherein the fluid in the cup body moves through the first valve and into the nipple, wherein the medicine in the medicine cup moves through the second valve and into the nipple, wherein air moves through the lid and through the third valve and into the medicine cup, and wherein air moves through the lid and through the fourth valve and into the cup body;
wherein the first attachment portion has a longitudinal axis that is coaxial with a longitudinal axis of the cup body.

8. The drinking cup as set forth in claim 7, wherein the flow control element has a second attachment portion that engages the lid and that has a longitudinal axis, wherein the second attachment portion has an outer perimeter and wherein the third valve is located within the outer perimeter of the second attachment portion, wherein the longitudinal axis of the second attachment portion is parallel to the longitudinal axis of the cup body but is not coaxial with the longitudinal axis of the cup body and is radially disposed from the longitudinal axis of the cup body;
wherein the flow control element has a third attachment portion that engages the lid and that has a longitudinal axis, wherein the third attachment portion has an outer perimeter and wherein the fourth valve is located within the outer perimeter of the third attachment portion, wherein the longitudinal axis of the third attachment portion is parallel to the longitudinal axis of the cup body but is not coaxial with the longitudinal axis of the cup body and is radially disposed from the longitudinal axis of the cup body.

9. The drinking cup as set forth in claim 1, wherein the cup body is releasably attachable to the lid, wherein the lid has a receiving portion, wherein the receiving portion has a projection receiving surface and a flow control engagement surface that has a convex shape that extends from the projection receiving surface; and
wherein the flow control element has an attachment portion, wherein the attachment portion has a projection and a lid engagement surface that has a concave shape that extends from the projection, wherein the flow control element is configured for releasable attachment with the lid, wherein when the flow control element and the lid are attached the flow control engagement surface engages the lid engagement surface, and wherein when the flow control element and the lid are attached the projection engages the projection receiving surface.

10. The drinking cup as set forth in claim 1, wherein the lid has a receiving portion, wherein the receiving portion has a flow control engagement surface; and
wherein the flow control element has an attachment portion, wherein the attachment portion has a lid engagement surface, wherein the flow control element is configured for releasable attachment with the lid, wherein when the flow control element and the lid are attached the flow control engagement surface engages the lid engagement surface through a frictional fit.

11. The drinking cup as set forth in claim 1, wherein the nipple is flexible.

12. A drinking cup, comprising:
a lid;
a cup body that engages the lid, wherein fluid is located in the cup body, wherein the cup body has a bottom surface that is disposed opposite to the lid when the cup body engages the lid;
a flow control element that has an upper surface and a lower surface;
a medicine cup into which medicine is disposed, wherein the medicine in the medicine cup moves through the flow control element and then through the lid; and
a straw that is located between the flow control element and the bottom surface of the cup body.

13. The drinking cup as set forth in claim 12, wherein the cup body is releasably attachable to the lid, wherein the straw directly faces and engages the lower surface of the flow control element, wherein the straw does not directly face and does not engage the bottom surface of the cup body.

14. The drinking cup as set forth in claim 12, wherein no straw is present between the upper surface of the flow control element and the lid, and further comprising a flip top spout that is carried by the lid and is movable from a closed position in which the fluid and medicine is prevented from being dispensed to an open position in which the fluid and medicine is capable of being dispensed.

15. The drinking cup as set forth in claim 12, wherein the straw is located in a cavity of the cup body and is outside of the medicine cup and engages the fluid that is located in the cup body, and further comprising a second straw that is located in the medicine cup and engages the medicine in the medicine cup.

16. The drinking cup as set forth in claim 15, wherein the flow control element has a first valve, a second valve, a third valve, and a fourth valve, wherein the fluid in the cup body moves through the straw and then through the first valve and then through the lid, wherein the medicine in the medicine cup moves through the second straw and then through the second valve and then through the lid, wherein air moves through the lid and through the third valve and into the medicine cup, and wherein air moves through the lid and through the fourth valve and into the cup body.

17. A drinking cup, comprising:
a lid that has a lower surface and an upper surface;
a cup body that engages the lid, wherein the cup body has a cavity, wherein fluid is located in the cavity of the cup body, wherein the cup body has a bottom surface that is disposed opposite to the lid;
a medicine cup into which medicine is located, wherein at least a portion of the medicine cup is located in the cavity of the cup body; and
a straw, wherein at least a portion of the straw is located between the lower surface of the lid and the bottom surface of the cup body.

18. The drinking cup as set forth in claim 17, wherein the straw is located in the medicine cup and does not directly face the bottom surface of the cup body.

19. The drinking cup as set forth in claim 17, further comprising:
a flow control element that has an upper surface and a lower surface, wherein at least a portion of the straw is located between the upper surface of the flow control element and the lower surface of the lid; and
a straw closing mechanism movable with respect to the lid from an open position in which the straw extends through the lid past the lower surface of the lid and past the upper surface of the lid, to a closed position in which the straw is prevented from extending through the lid past the upper surface of the lid
wherein a straw is not present in the medicine cup and wherein a straw is not present between the lower surface of the flow control element and the bottom surface of the cup body.

20. The drinking cup as set forth in claim 17, further comprising:
a flow control element that has an upper surface and a lower surface, wherein the straw is located between the lower surface of the flow control element and the bottom surface of the cup body; and
a second straw, wherein at least a portion of the second straw is located between the upper surface of the flow control element and the lower surface of the lid.
